(19) United States
(12) Patent Application Publication
(10) Pub. No.: US 2018/0053017 A1
(43) Pub. Date: Feb. 22, 2018

(54) PROGRAMMABLE LOGIC DEVICE, INFORMATION PROCESSING APPARATUS, AND PROCESSING METHOD

(71) Applicant: FUJITSU LIMITED, Kawasaki-shi (JP)

(72) Inventors: Takashi Shimizu, Kawasaki (JP); TAKASHI MIYOSHI, Ohta (JP)

(73) Assignee: FUJITSU LIMITED, Kawasaki-shi (JP)

(21) Appl. No.: 15/658,466

(22) Filed: Jul. 25, 2017

(30) Foreign Application Priority Data
Aug. 18, 2016 (JP) 2016-160304

(51) Int. Cl. G06F 21/76; G06F 21/78; G06F 21/60

(52) U.S. Cl. CPC G06F 21/76; G06F 21/606; G06F 21/78

(57) ABSTRACT

A programmable logic device includes: an encryption unit configured to encrypt data based on a process of an arithmetic processing unit and first checking data added to the data to generate encrypted data, based on an encryption key corresponding to identification information allocated to the arithmetic processing unit, the arithmetic processing unit being implemented in a specific circuit area of a plurality of programmable circuit areas; and a transmission unit configured to transmit identification information output from the specific circuit area and the encrypted data to an authentication unit, and the authentication unit is configured to decrypt the encrypted data received from the transmission unit based on the encryption key corresponding to the identification information received from the transmission unit and to perform an authentication process of decrypted data based on the first checking data added to the decrypted data.

### CROSS-REFERENCE TO RELATED APPLICATION

This application is based upon and claims the benefit of priority of the prior Japanese Patent Application No. 2016-160304, filed on Aug. 18, 2016, the entire contents of which are incorporated herein by reference.

### FIELD

The invention relates to a programmable logic device, an information processing apparatus, and a processing method.

### BACKGROUND

Recently, a technique of using a reconfigurable integrated circuit (IC) such as an FPGA for computing in an information processing apparatus such as a server has been studied. FPGA is an abbreviation of field-programmable gate array. The integrated circuit such as the FPGA may be referred to as a “programmable logic device.”

In an information processing apparatus on which an FPGA is mounted, a logic circuit can be configured and operated in the FPGA.

As an example of a use form of an FPGA in an information processing apparatus, a logic circuit that accesses a memory may be configured in the FPGA and the FPGA may serve as a processor of the information processing apparatus. In other words, the FPGA may be handled to be equivalent to a processor such as a central processing unit (CPU).

Patent Document 1: Japanese National Publication of International Patent Application No. 2008-512909

Patent Document 2: Japanese Patent Application Laid-Open No. 2009-80799

With spread of a cloud service, it is supposed that the FPGA is mounted on a server (which may hereinafter be referred to as a cloud server or a host machine) that provides the cloud service.

In the cloud server, for example, it is considered that a desired arithmetic circuit is configured in an FPGA by a user of a client machine and an operation of returning an operation result by the arithmetic circuit in response to an access from the client machine is performed.

However, in the cloud system, it may be difficult to individually estimate a security risk for an arithmetic circuit implemented in the FPGA by a user.

### SUMMARY

According to an aspect of the embodiments, a programmable logic device may include a plurality of programmable circuit areas. The programmable logic device may include an encryption unit and a transmission unit. The encryption unit may be configured to encrypt data based on a process of an arithmetic processing unit and first checking data added to the data to generate encrypted data, the arithmetic processing unit being implemented in a specific circuit area of the plurality of programmable circuit areas. The encryption may be performed based on an encryption key corresponding to identification information allocated to the arithmetic processing unit. The transmission unit may be configured to transmit identification information output from the specific circuit area and the encrypted data to an authentication unit. The authentication unit may be configured to decrypt the encrypted data received from the transmission unit based on the encryption key corresponding to the identification information received from the transmission unit and to perform an authentication process of decrypted data based on the first checking data added to the decrypted data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an operation of a cloud system;

FIG. 2 is a diagram illustrating an example of management of a page table by a CPU;

FIG. 3 is a diagram illustrating an example of an operation of a cloud system;

FIG. 4 is a diagram illustrating an example of management of a page table by an FPGA type processor;

FIG. 5 is a block diagram illustrating an example of a configuration of an information processing system according to an embodiment;

FIG. 6 is a sequence diagram illustrating an example of an operation of the information processing system according to the embodiment;

FIG. 7 is a sequence diagram illustrating an example of an operation of the information processing system according to the embodiment;

FIG. 8 is a sequence diagram illustrating an example of an operation of the information processing system according to the embodiment;

FIG. 9 is a diagram illustrating an example of a hardware configuration of a computer according to the embodiment;

FIG. 10 is a block diagram illustrating an example of a functional configuration of a host machine according to the embodiment;

FIG. 11 is a block diagram illustrating an example of a functional configuration of a management machine according to the embodiment;

FIG. 12 is a diagram illustrating an example of a data configuration of a user DB;

FIG. 13 is a block diagram illustrating a configuration of an information processing system according to a practical example of the embodiment;

FIG. 14 is a block diagram illustrating an example of a configuration of an FPGA illustrated in FIG. 13;

FIG. 15 is a diagram illustrating an example of an operation of the FPGA based on an ID and an address output from circuit area B illustrated in FIG. 14;

FIG. 16 is a diagram illustrating an example of an operation of the FPGA based on an ID and an address output from circuit area B illustrated in FIG. 14;

FIG. 17 is a diagram illustrating an example of an operation of the FPGA based on an ID and an address output from circuit area B illustrated in FIG. 14;

FIG. 18 is a diagram illustrating an example of an operation of the FPGA based on an ID and an address output from circuit area B illustrated in FIG. 14;

FIG. 19 is a block diagram illustrating a first modified example of a configuration of the FPGA illustrated in FIG. 13;

FIG. 20 is a block diagram illustrating a second modified example of a configuration of the FPGA illustrated in FIG. 13;

FIG. 21 is a block diagram illustrating a configuration of an information processing system according to a modified example of the embodiment;

FIG. 22 is a sequence diagram illustrating a configuration of an information processing system according to a modified example of the embodiment;

FIG. 23 is a block diagram illustrating a configuration of a management machine according to a modified example of the embodiment; and

FIG. 24 is a block diagram illustrating a configuration of an information processing system according to a practical example of a modified example.

### DESCRIPTION OF EMBODIMENTS

Hereinafter, an embodiment of the invention will be described with reference to the accompanying drawings. In the below-described embodiment is only exemplary and is not intended to exclude application of various modifications or techniques which are not explicitly described. For example, the embodiment can be modified in various forms without departing from the gist thereof.

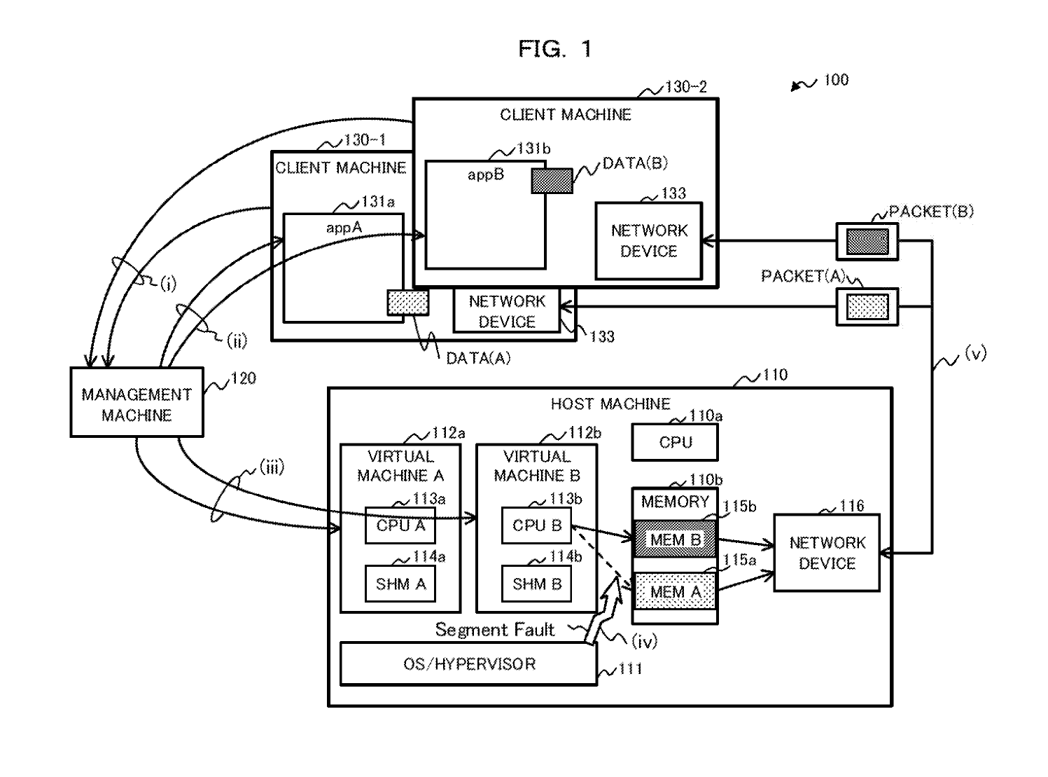

In the drawings which are used in the following embodiment, elements referenced by the same reference signs represent identical or similar elements unless particularly mentioned. In the following description, when a plurality of devices having the same names are not distinguished, numerals subsequent to hyphen “-” of reference signs may be omitted or alphabets of reference signs may be omitted. For example, when client machines 130-1 and 130-2 illustrated in FIG. 1 are not distinguished from each other, the client machines are simply described as client machines 130. When applications 131a and 131b illustrated in FIG. 1 are not distinguished from each other, the applications are simply described as applications 131.

### [1] Embodiment

### [1-1] Security Risk in Cloud System

First, a risk in terms of security in a cloud system will be described below.

FIG. 1 is a diagram illustrating an example of an operation of a cloud system 100 in which a CPU is used as a processor of a host machine 110. As illustrated in FIG. 1, for example, the cloud system 100 includes a host machine 110, a management machine 120, and a plurality of (two in the example illustrated in FIG. 1) client machines 130-1 and 130-2.

As illustrated in FIG. 1, applications 131a and 131b of the client machines 130-1 and 130-2 transmit a service use request to the management machine 120 (see arrows (i) in FIG. 1). Hereinafter, it is assumed that a service is provision of a virtual machine.

The management machine 120 that manages the cloud system authenticates the service based on the request and transmits, for example, an identifier (ID) of a virtual machine to the applications 131 (see arrows (ii)). The management machine 120 transmits information received from the client machines 130, such as a program or data which is used to use the virtual machine, to the host machine 110 (see arrows (iii)).

The host machine 110 executes an operating system (OS) or hypervisor 111 (which may hereinafter be referred to as an OS/HPV 111) using hardware resources such as a CPU 110a and a memory 110b. Virtual machines 112a and 112b are executed under the control of the OS/HPV 111.

In the host machine 110, the hardware resources such as the CPU 110a and the memory 110b are shared by a plurality of virtual machines 112a and 112b. For example, the virtual machine 112a uses a CPU 113a and a shared memory (SHM) 114a which are implemented in at least a part of the hardware resources. In addition, the virtual machine 112b uses a CPU 113b and a shared memory 114b which are implemented in at least a part of the hardware resources.

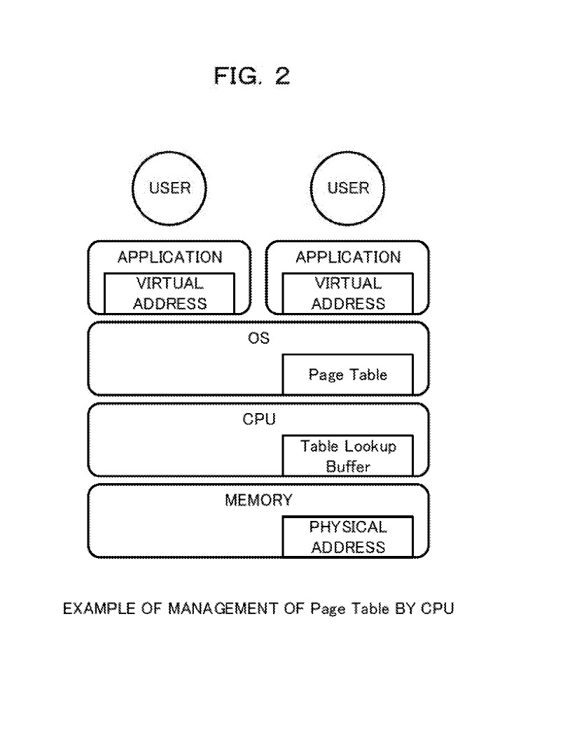

Now, management of memory addresses in a computer will be described. As illustrated in FIG. 2, a user describes an application using a virtual address and the OS determines a physical address which is allocated to the virtual address. Correlation between the virtual address and the physical address is managed by a page table. The page table is an example of information for managing allocation of a memory.

The CPU copies a conversion table of addresses which are frequently used to a table lookup buffer (TLB) in the CPU to speed up an access of the OS to the page table by hardware. Then, the CPU converts the virtual address designated by the application into a physical address based on the TLB and accesses the memory using the converted physical address.

In this way, since the user does not recognize the physical address but recognizes the virtual address, it is difficult for the user to access the physical address which is used by another user's application.

In the example illustrated in FIG. 1, the shared memories 114a and 114b are managed using virtual addresses and are allocated to physical addresses of the memory 110b. Hereinafter, an address area of the memory 110b which is allocated to the shared memory 114a is referred to as a memory area 115a and an address area of the memory 110b which is allocated to the shared memory 114b is referred to as a memory area 115b.

In the virtual machines 112a and 112b, an access to a storage area in the memory 110b other than the corresponding memory areas 115a and 115b is restricted by the OS/HPV 111.

Accordingly, for example, even when a user of the application 131b tries to access the memory area 115a corresponding to another user's virtual machine 112a using the virtual machine 112b, the access is inhibited by the OS/HPV 111. For example, as indicated by an arrow (iv) in FIG. 1, the OS/HPV 111 detects segmentation fault and performs an error process or the like.

Operation results of the virtual machines 112 stored in the memory areas 115 are transmitted and received between network devices 133 of the client machines 130 using the virtual machines 112 via a network device 116 of the host machine 110 (see arrows (v)).

For example, the operation result stored in the memory area 115a is stored in a packet (A) and is transmitted from the network device 116 to the network device 133 of the client machine 130-1, and data (A) in the packet (A) is handed over to the application 131a. The operation result stored in the memory area 115b is stored in a packet (B) and is transmitted from the network device 116 to the network device 133 of the client machine 130-2, and data (B) in the packet (B) is handed over to the application 131b.

As described above, in the cloud system 100 in which the CPU 110a is used as a processor of the host machine 110, the user of the application 131 performs a process using the virtual machine 112 which is provided by the OS/HPV 111. Accordingly, even when the user tries to access a storage area of another user's memory 110b, the access can be inhibited by the OS/HPV 111.

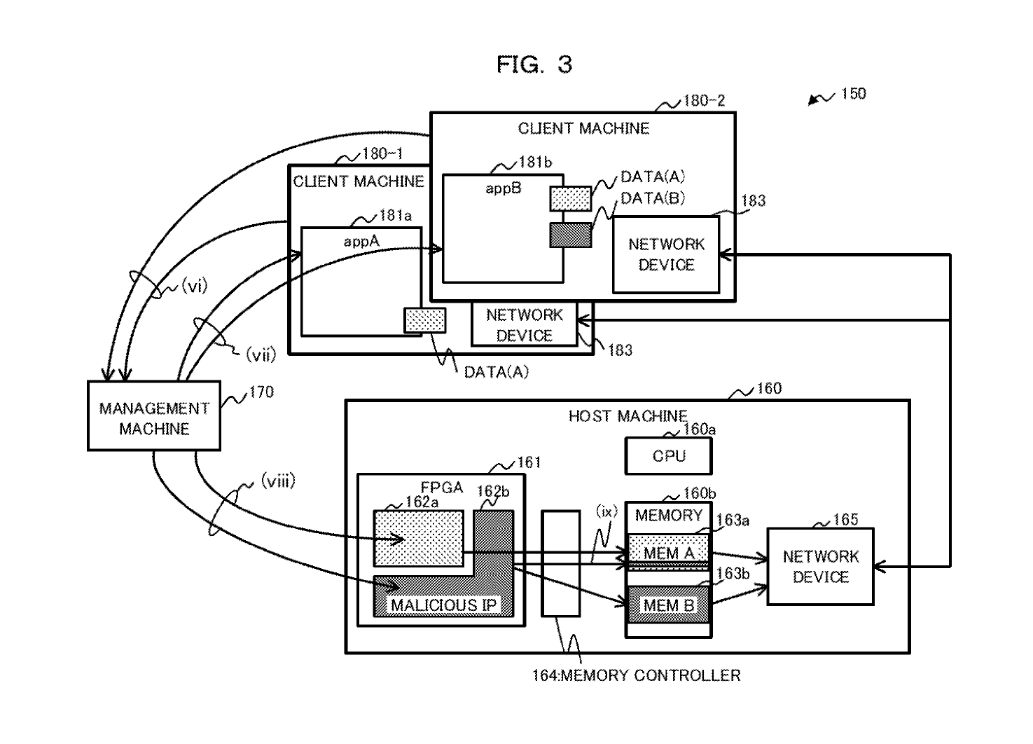

A case in which an FPGA is used as a process of a host machine will be described below. FIG. 3 is a diagram illustrating an example of an operation of a cloud system 150 in which an FPGA is used as a process of a host machine 160.

As illustrated in FIG. 3, applications 181a and 181b of client machines 180-1 and 180-2 transmit a service use request to a management machine 170 (see arrows (vi) in FIG. 3). The applications 181 transmit information of a processing circuit to be written to an FPGA 161 of the host machine 160, such as an intellectual property (IP) core, to the management machine 170.

An IP is an example of a functional block which can be reused in the FPGA and an IP core is an example of information which is used to design a functional block constituting the FPGA. The IP core may include a software macro, a hardware macro, or a combination thereof. The software macro may include a program code which is provided at a register transfer level (RTL). The RTL is an example of a scheme for describing design data of a logic circuit. The hardware macro may include information of a circuit block which is incorporated into the FPGA. The IP core may be provided as a hardware macro in consideration of a risk of changing the software macro.

The management machine 170 authenticates the service based on the request and transmits, for example, an ID of a virtual machine to each application 181 (see arrows (vii)).

The management machine 170 implements processing circuits 162a and 162b, that is, accelerators, in the FPGA 161 of the host machine 160 based on the IP cores received from the client machines 180 (see arrows (viii)).

In the host machine 160, the processing circuits 162a and 162b implemented in the FPGA 161 operate using memory areas 163a and 163b which are address areas of the memory 160b via a memory controller 164. In the host machine 160, the CPU 160a and the FPGA 161 serve as a processor. For example, write requests from the processing circuits 162a and 162b are collected in a write block and are written to the memory 160b via a bus.

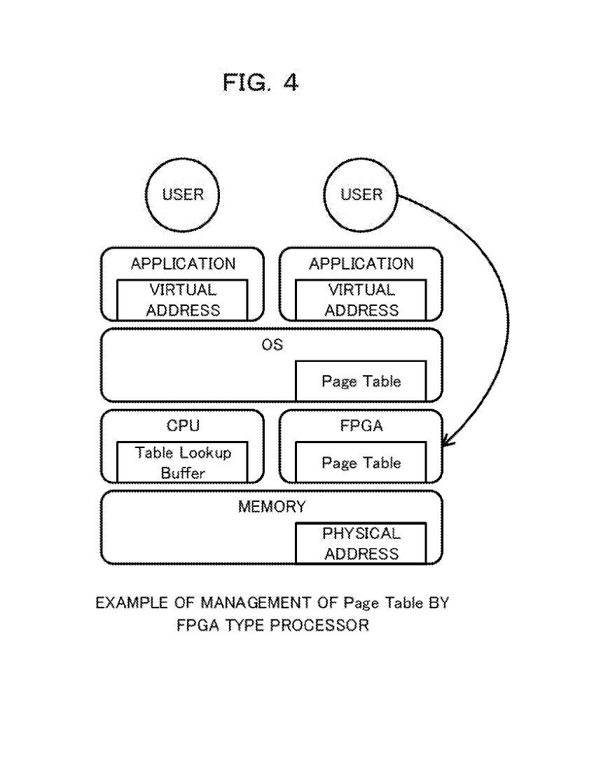

A case in which an FPGA type process is used for management of memory addresses in a computer will be described below. As illustrated in FIG. 4, an FPGA disposed in a cache coherent bus which is handled equivalent to a CPU copies a page table from the OS.

In the cloud system 150, it is supposed that a processing circuit implemented in the FPGA is prepared by a user. Accordingly, depending on design of the processing circuit, the user may operate the page table copied by the FPGA. For example, the FPGA may convert a physical address set in the page table into a physical address of a memory which is used by another user.

The conversion of a physical address set in the page table may be performed by rewriting information set in the page table, or information read from the page table may be converted in the course of accessing of the FPGA to the memory.

The access of the FPGA to a memory which is used by another user may be caused by a design error of the processing circuit or the like in addition to malicious operation of the FPGA by the user.

In the example illustrated in FIG. 3, for example, when the processing circuit 162b is a malicious IP prepared by a user of the application 181b, a defense mechanism of the OS does not operate in an access from the processing circuit 162b to the memory area 163a (see an arrow (ix)).

Accordingly, when writing of data from the processing circuit 162b to the memory area 163a which is used by another user, the host machine 160 has a difficulty in detecting such unauthorized writing. The malicious IP can be said to be an unauthorized processor, for example, a reconfigurable processor which is programmed by a malicious user.

In this way, when a user can freely design a processor, the FPGA type processor can perform a direct access to hardware as well as a secure access which is provided by the OS. Accordingly, a security risk in the host machine including the FPGA increases.

### [1-2] Example of Configuration of Information Processing System According to Embodiment

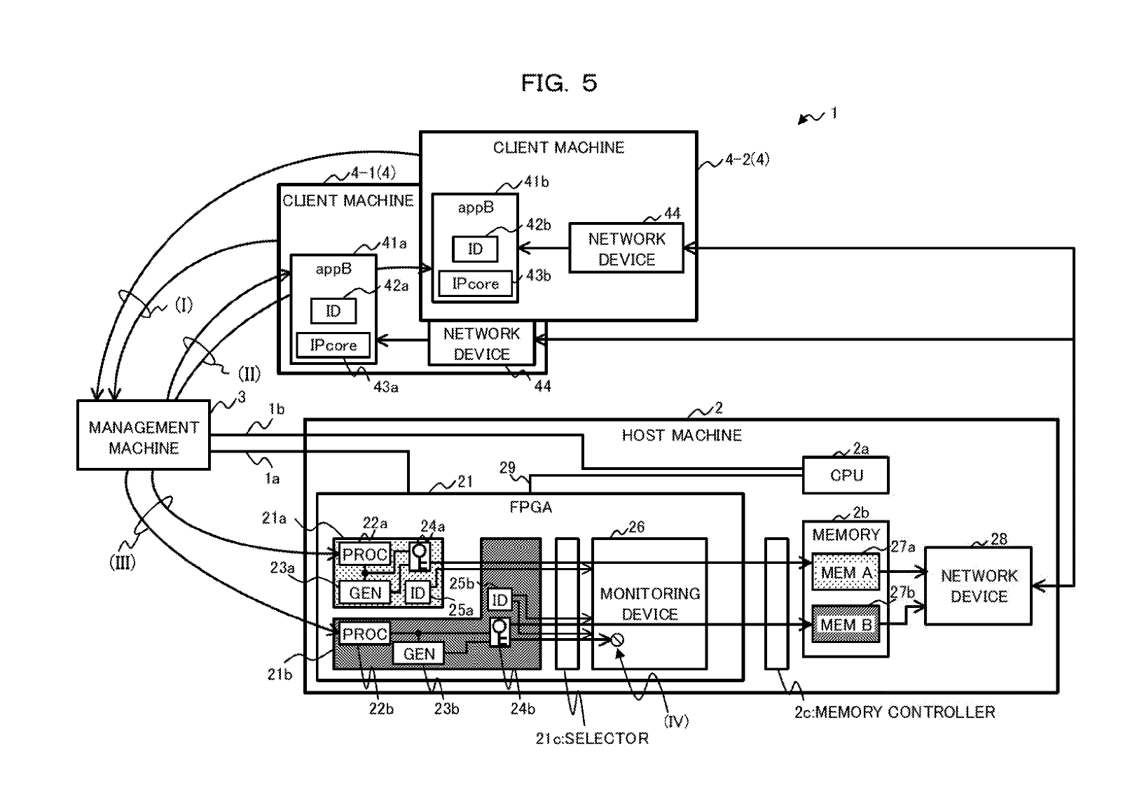

Therefore, in the embodiment, a security risk in an information processing apparatus including a reconfigurable integrated circuit is decreased using the following configuration. FIG. 5 is a block diagram illustrating an example of a configuration of an information processing system 1 according to the embodiment.

As illustrated in FIG. 5, the information processing system 1 includes, for example, a host machine 2, a management machine 3, and a plurality of (two in the example illustrated in FIG. 5) client machines 4-1 and 4-2. A plurality of host machines 2 or a plurality of management machines 3 may be present in the information processing system 1, or three or more client machines 4 may be present in the information processing system 1.

The host machine 2 is an example of an information processing apparatus. Examples of the host machine 2 include various computers such as a server and a personal computer (PC). For example, the host machine 2 may be used in a cloud service of providing as a processor an FPGA which is cache coherent and in which a processing circuit desired by a user is implemented in response to a request from the user.

The host machine 2 may include, for example, a CPU 2a, a memory 2b, a memory controller 2c, an FPGA 21, and a network device 28. The CPU 2a is an example of a processor that performs a variety of control or operations. The memory 2b is an example of hardware that stores information such as various data or programs. Examples of the memory 2b include a volatile memory such as a random access memory (RAM). The memory controller 2c processes a memory access requested by the CPU 2a and the FPGA 21. Examples of the memory controller 2c include a memory management unit (MMU).

The FPGA 21 is a reconfigurable integrated circuit and is an example of a programmable logic device including a plurality of programmable circuit areas. Two or more FPGAs 21 may be present in the host machine 2.

Before a cloud service is provided such as when the host machine 2 is manufactured or shipped or when the host machine 2 starts, a state in which no logic block is configured in the FPGA 21 may be present. The example illustrated in FIG. 5 shows a state in which logic blocks are configured in response to requests from the client machines 4-1 and 4-2 at the operation stage of the information processing system 1.

The FPGA 21 may be disposed in a cache coherent bus which is handled equivalent to the CPU 2a or control of maintaining cache coherency which is used in a memory access may be performed between the FPGA 21 and the CPU 2a.

As illustrated in FIG. 5, the FPGA 21 may include, for example, a first circuit area 21a, a second circuit area 21b, a selector 21c, and a monitoring device 26.

The first circuit area 21a and the second circuit area 21b are examples of a specific circuit area of a plurality of circuit areas of the FPGA 21. The specific circuit area may refer to a circuit area which is allocated to a user, like the first circuit area 21a and the second circuit area 21b in the example illustrated in FIG. 5.

A processing circuit 22a, a generation unit 23a, an encryption device 24a, and an ID output unit 25a may be configured in the first circuit area 21a. A processing circuit 22b, a generation unit 23b, an encryption device 24b, and an ID output unit 25b may be configured in the second circuit area 21b.

The processing circuits 22, the generation units 23, and the ID output units 25 may be circuits which are configured in response to a request (for example, an IP core) from the client machines 4. The encryption device 24 is a circuit in which an IP core is prepared by the management machine 3 and may be configured to be unable to interfere with the client machines 4.

The processing circuits 22 may be freely designed by general users. On the other hand, when the generation units 23 and the ID output units 25 can be freely designed, there is a possibility of influencing an operation such as a memory access. Therefore, for example, by causing a user to use an IP core which is prepared in advance such as an existing library, the generation units 23 and the ID output units 25 may be provided.

The processing circuits 22 (described as “PROC” (PROCESSOR) in the example illustrated in FIG. 5) is an example of an arithmetic processing unit which is implemented by a specific circuit area of the plurality of circuit areas of the FPGA 21. The processing circuits 22 may perform, for example, a process based on information transmitted from the client machines 4 and may output data based on the process to the generation unit 23 and the encryption device 24. The processing circuits 22 may output an access request to a memory area 27 allocated to the processing circuit 22 to the selector 21c based on management information (not illustrated) for managing addresses of the memory 2b.

The management information is an example of information for managing identification information allocated to the processing circuit 22 and an address of a storage area allocated to the processing circuit 22. Examples of the management information include a page table which is managed by an OS executed in the CPU 2a or the FPGA 21. As illustrated in FIG. 5, the memory 2b may include a memory area 27a which is an address area of a physical address allocated to the processing circuit 22a and a memory area 27b which is an address area of a physical address allocated to the processing circuit 22b.

In the management information of the processing circuits 22a and 22b, an address which is determined in advance exclusively from an address determined in the management information of the other circuit area. In other words, an address of the memory areas 27 which do not overlap each other may be set in the management information of the first circuit area 21a or the second circuit area 21b.

In some cases, the host machine 2 does not include the memory area 27 (or the memory 2b) to which encrypted data from the FPGA 21 is written. For example, the memory area 27 (the memory 2b) may be included in another host machine or an arbitrary information processing apparatus.

The generation unit 23 (described as “GEN” (GENERATOR) in the example illustrated in FIG. 5) may generate first checking data by performing a specific process on data based on the process of the processing circuit 22 and may add the first checking data to the data output from the processing circuit 22.

Examples of the first checking data include information related to original data, such as an error detection and correction code which is generated based on original data. The specific process may include, for example, a process of generating an error detection and correction code. Examples of the error detection and correction code include a checksum and a cyclic redundancy code (CRC). In the following description, the specific process for generating the first checking data may be set to generating a checksum, and the first checking data may be referred to as “sum” or “sec.”

The encryption device 24 is an example of an encryption unit that encrypts data based on the process of the processing circuit 22 and the first checking data added to the data based on an encryption key corresponding to identification information allocated to the processing circuit 22 to generate encrypted data.

The identification information allocated to the processing circuit 22 is an identifier which is used to provide a cloud service and may be, for example, an ID of the circuit area 21a or 21b or an ID of the processing circuit 22 (accelerator). When the encryption device 24 is configured in the FPGA 21, an encryption key corresponding to the identification information allocated to the processing circuit 22 (or the circuit area 21a or 21b) as a destination of the encryption device 24 may be set by the management machine 3.

The encryption device 24 may decrypt encrypted data read from the memory area 27 using the encryption key corresponding to the identification information allocated to the processing circuit 22 and output the decrypted data to the processing circuit 22.

Encryption and decryption by the encryption device 24 can be performed using various existing schemes. For example, a symmetric encryption scheme may be used as the encryption scheme, or an asymmetric encryption scheme may be used instead of the symmetric encryption scheme.

The ID output units 25 (described as “ID” in the example illustrated in FIG. 5) may output identification information of the processing circuits 22 to the selector 21c. The identification information output from the ID output units 25 are the same as the identification information allocated to the processing circuits 22, but the ID output unit 25 may output identification information allocated to another user's processing circuit 22 in a malicious IP.

The selector 21c is an example of a transmission unit that transmits identification information output from the specific circuit area and the encrypted data to the authentication unit. For example, the selector 21c selects any set of encrypted data, identification information, and address of the encrypted data, the identification information, and the addresses input from a plurality of circuit areas (reference numerals 21a and 21b in the example illustrated in FIG. 5) and outputs the selected set to the monitoring device 26. Examples of the selector 21c include a multiplexer (MUX) that distributes one of a plurality of input signals to an output.

The monitoring device 26 is an example of the authentication unit that decrypts the encrypted data from the selector 21c based on the encryption key corresponding to the identification information received from the selector 21c, and performs an authentication process of the decrypted data based on the first checking data added to the decrypted data.

For example, the monitoring device 26 may perform the authentication process in the following order.

(a) The encryption key corresponding to the identification information received from the ID output unit 25 is acquired from information (not illustrated) indicating a correlation between the identification information and the encryption key and the encrypted data received from the encryption device 24 is decrypted using the acquired encryption key.

(b) A specific process is performed on the decrypted data to generate second checking data. The specific process is the same as the process which is performed by the generation unit 23.

(c) It is determined whether the generated second checking data coincides with the decrypted first checking data.

By performing the processes of (a) to (c), the monitoring device 26 may determine that authentication succeeds when the second checking data coincides with the first checking data. On the other hand, the monitoring device 26 may determine that authentication fails and inhibit writing of the decrypted data to the memory area 27, when the second checking data does not coincide with the first checking data.

In this way, for example, when the specific circuit area including an arithmetic processing unit falsifies the identification information, the authentication process in the authentication unit fails. Accordingly, by allowing a malicious IP to impersonate another circuit area (to use identification information of another circuit area), it is possible to prevent write unauthorized data from being written to another user's storage area.

The monitoring device 26 may maintain management information such as a page table and may authenticate an address of a write destination received from the processing circuit 22 based on the received address of the write destination and the address of the memory area 27 allocated to the processing circuit 22.

When authentication of both data and address succeeds in the authentication process, the monitoring device 26 may transmit the address and the decrypted data to the memory controller 2c. At this time, the monitoring device 26 may encrypt the decrypted data using the encryption key which has been used for the decryption and transmit the encrypted data to the memory controller 2c.

The monitoring device 26 is disposed in the FPGA 21 in the example illustrated in FIG. 5, but the invention is not limited thereto and the monitoring device 26 may be an integrated circuit (IC) that is disposed between the FPGA 21 and the memory controller 2c outside the FPGA 21.

The memory controller 2c may perform control of writing the data input from the monitoring device 26 to the memory area 27 allocated to the processing circuit 22 in the memory 2b.

The network device 28 may communicate with the client machine 4 via a network which is not illustrated. The network device 28 may be used for communication between the management machine 3 and the host machine 2. Examples of the network include the Internet, a local area network (LAN), and a wide area network (WAN).

The management machine 3 is an example of a management device that manages the host machine 2. Examples of the management machine 3 include an information processing apparatus such as various computers such as a server and a PC.

The management machine 3 may perform control of configuring the elements in the FPGA 21 based on first information which is used to configure the processing circuit 22 and the like and second information which is used to configure the encryption device 24, the selector 21c, and the like in response to a request from the client machine 4. The second information may include information which is used to configure the monitoring device 26.

The first information and the second information may be IP cores. The IP core may include a software macro, a hardware macro, or a combination thereof as described above. In the following description, the first information may be referred to as a process IP core and the second information may be referred to as an encryption IP core.

The control of configuring a logic circuit in the FPGA 21 may be realized using various methods. For example, as illustrated in FIG. 5, the management machine 3 and the FPGA 21 of the host machine 2 may be connected via a dedicated line 1a and the management machine 3 may implement an accelerator in the FPGA 21. In the example illustrated in FIG. 5, for the purpose of convenience, the dedicated line 1a is connected directly to the FPGA 21, but the dedicated line 1a may be connected to the FPGA 21 via a network.

Alternatively, the management machine 3 may instruct the OS which is executed by the CPU 2a of the host machine 2 to implement the accelerator in the FPGA 21 via a communication line 1b and the instructed OS may implement the accelerator in the FPGA 21 via a control line 29. In the example illustrated in FIG. 5, for the purpose of convenience, the communication line 1b is connected to the CPU 2a, but the communication line 1b may be connected to the network device 28 via a network or directly.

The client machine 4 is an example of a terminal device that accesses the host machine 2. Examples of the client machine 4 include an information processing apparatus such as various computers such as a PC, a server, a smartphone, and a tablet.

The client machine 4 includes, for example, a network device 44 and executes an application 41 using a CPU, a memory, and the like which are not illustrated. For example, the application 41a is operated by a user in the client machine 4-1 and the application 41b is operated by a user in the client machine 4-2.

The network device 44 communicates with the host machine 2 via a network which is not illustrated. The network device 44 may be used for communication between the client machine 4 and the management machine 3. Examples of the network include the Internet, a LAN, and a WAN.

The client machine 4 may include a storage area of a memory or the like in which an ID 42 and an encryption key transmitted from the management machine 3 and an IP core 43 (for example, a process IP core) to be transmitted to the management machine 3 is stored.

The memory of a read destination of data by the client machine 4 is not the above-mentioned memory area 27 but may be a storage device such as a memory or an HDD to which data is transmitted from the memory area 27. The storage device to which data is transmitted may be included in the host machine 2 or may be included in a device other than the host machine 2.

### [1-3] Example of Operation

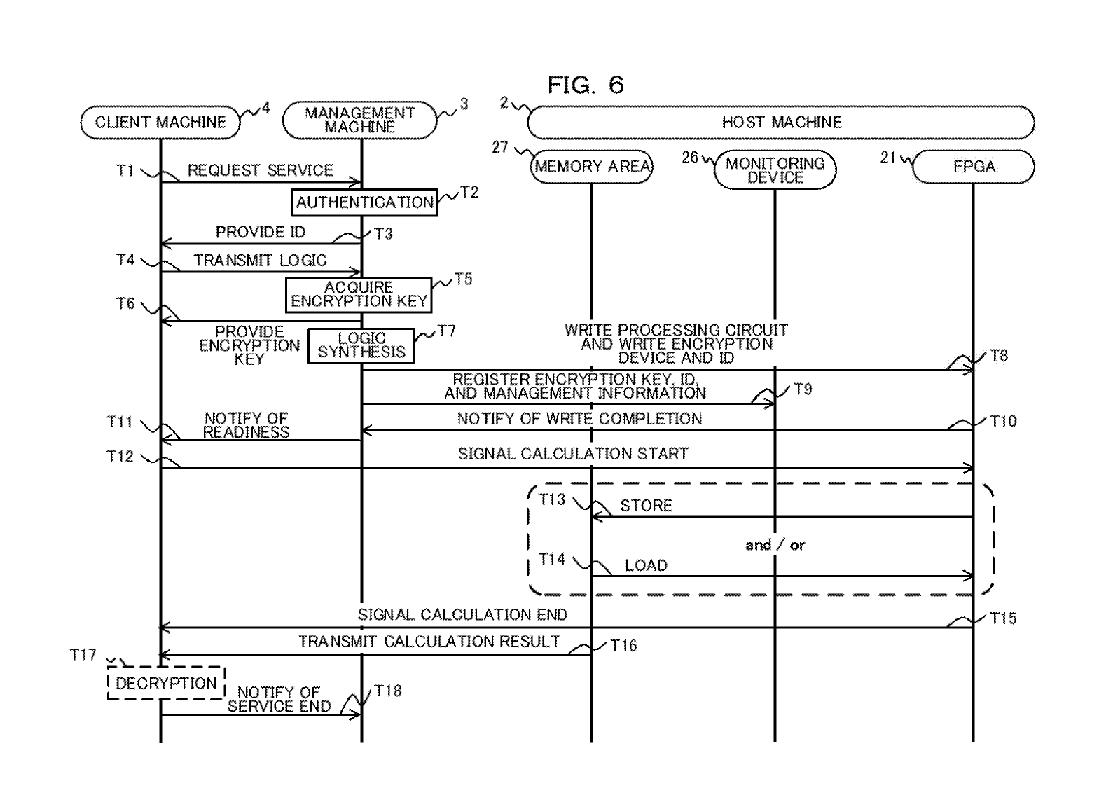

An example of an operation of the information processing system 1 having the above-mentioned configuration will be described below with reference to FIGS. 6 to 8.

As illustrated in FIG. 6, the client machine 4 transmits a request for a service of using the FPGA 21 to the management machine 3 (process T1: arrows (I) in FIG. 5). The management machine 3 authenticates the service in response to the received request (process T2), issues an ID, and transmits the ID to the application 41 (process T3: arrows (II) in FIG. 5).

The client machine 4 transmits the logic of an accelerator, for example, an IP core 43, to the management machine 3 (process T4). The logic of the accelerator may be an IP core 43 which is prepared by a client, for example, a user of the application 41. Process T4 may be performed at the same time as transmission of process T1.

Subsequently, the management machine 3 acquires an encryption key (process T5) and provides the acquired encryption key to the client machine 4 (process T6). The management machine 3 performs logic synthesis of the logic of the accelerator (process T7).

For example, in the logic synthesis, an IP core such as an RTL which is represented in a hardware description language (HDL) may be converted into a net list of a gate level to perform design for implementing a logic circuit. The net list is a format of expression of design data in which a list of wires (nets) connecting elements is described.

As the HDL, a hardware description language such as Verilog HDL or VHSIC HDL (VHDL) may be used. VHSIC is an abbreviation of very high speed integrated circuits.

The management machine 3 arranges a design of the processing circuit 22 which is synthesized by the logic synthesis in the FPGA 21 and arranges the encryption device 24 that performs encryption using the acquired encryption key or the selector 21c in a memory interface of the FPGA 21.

For example, the management machine 3 writes the processing circuit 22 (and peripheral circuits such as the generation unit 23 or the ID output unit 25), the encryption device 24, and the selector 21c to the FPGA 21 (process T8: arrows (III) in FIG. 5). The management machine 3 may register the ID allocated to the application 41 in the ID output unit 25 at the time of writing the peripheral circuits.

The management machine 3 registers the IDs and the encryption keys corresponding to the processing circuit 22 and the encryption device 24 implemented in the FPGA 21 and the page table in the monitoring device 26 (process T9).

When writing to the FPGA 21 is completed, the FPGA 21 transmits a write completion message to the management machine 3 (process T10). When the write completion message is received, the management machine 3 transmits a readiness message to the client machine 4 (process T11).

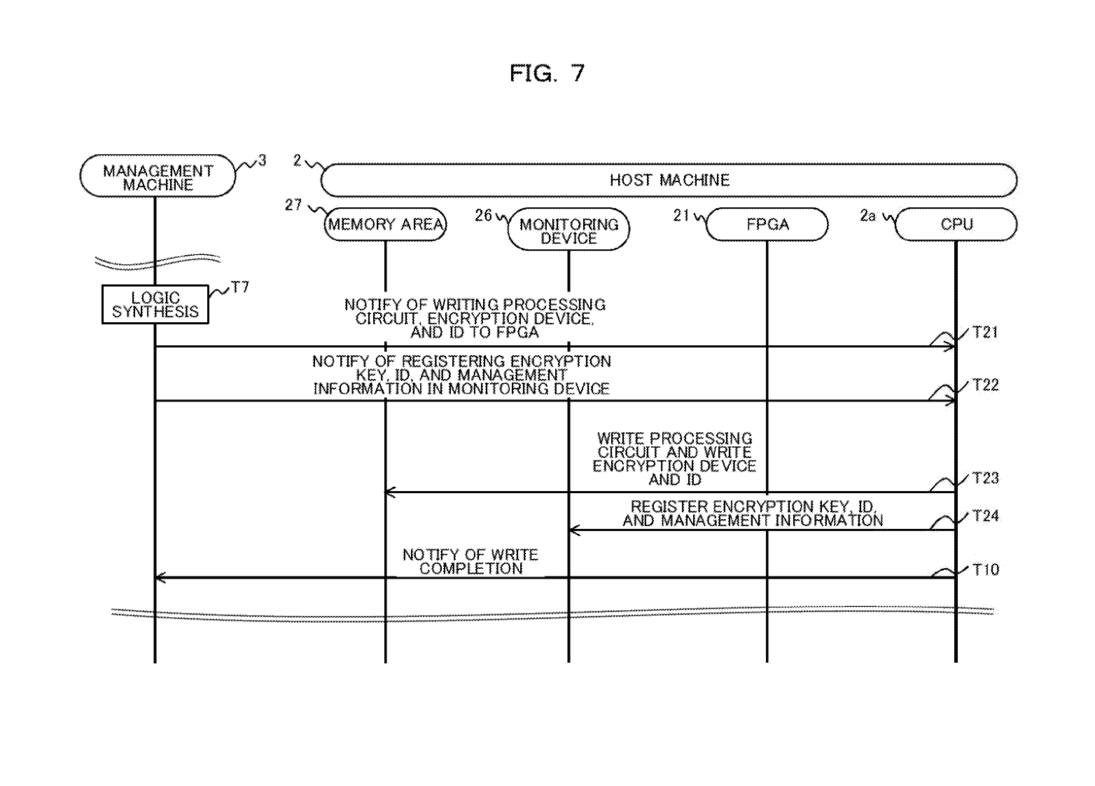

In another example, as illustrated in FIG. 7, when the logic synthesis of the accelerator is performed in process T7, the management machine 3 may notify the CPU 2a of the host machine 2 of writing of the processing circuit 22, the encryption device 24, and the like to the FPGA 21 (process T21). The management machine 3 may notify the CPU 2a of registering the ID, the encryption key, and the management information in the monitoring device 26 (process T22).

The CPU 2a may write the processing circuit 22, the encryption device 24, and the like to the FPGA 21 using the OS (process T23) and may register the ID, the encryption key, and the management information in the monitoring device 26 (process T24). Process T10 is the same as illustrated in FIG. 6. In FIG. 7, the logic synthesis of process T7 may be performed by the host machine 2.

Subsequently, the client machine 4 transmits an instruction to start a specific arithmetic operation (a calculation start signal) to the processing circuit 22 of the FPGA 21 which is specified by the ID 42 (process T12). When the calculation start signal is received, a runtime starts in the host machine 2 and a driver of the FPGA 21 is loaded.

The FPGA 21 performs calculation using the processing circuit 22. In the course of calculation, at least one of storing data encrypted data in the memory area 27 allocated to the processing circuit 22 (process T13) and loading the encrypted data stored in the memory area 27 to the FPGA 21 (process T14) may be performed.

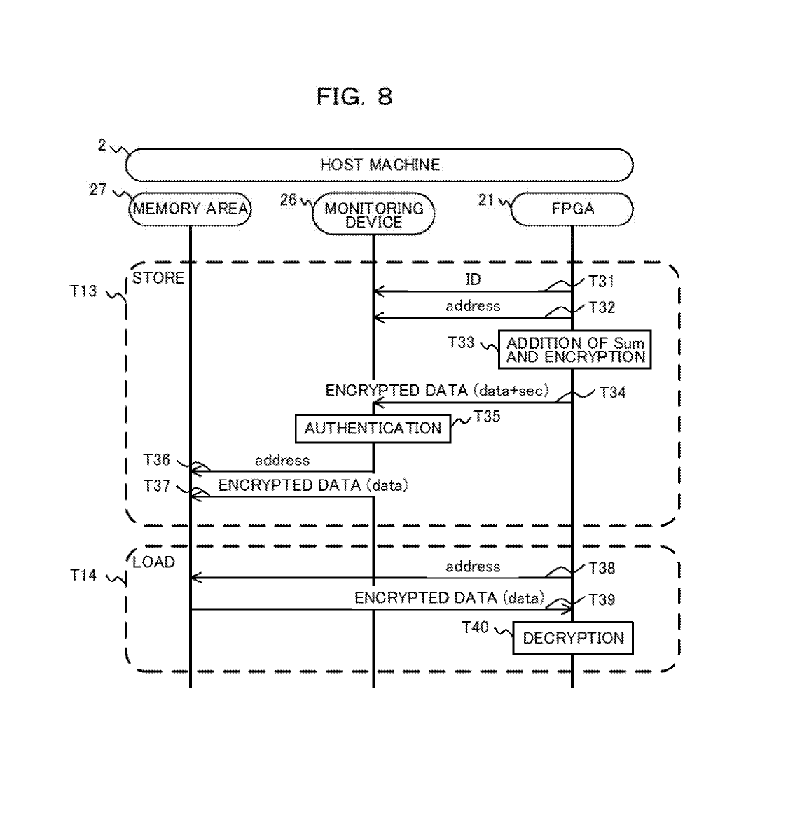

As illustrated in FIG. 8, the storing (process T13 in FIG. 6), the ID of the processing circuit 22 and the address of the memory area 27 to be stored are transmitted from the FPGA 21 to the monitoring device 26 (processes T31 and T32). The generation unit 23 generates a sum based on the calculation result of the processing circuit 22 and the encryption device 24 encrypts data obtained by adding the sum to the calculation result (process T33). Then, the encrypted data including the data and the sec (sum) is transmitted to the monitoring device 26 (process T34).

The monitoring device 26 performs an authentication process based on the ID, the address, and the encrypted data received via the selector 21c (process T35). When the authentication succeeds, the monitoring device 26 transmits the encrypted data in which the address and the calculation result are encrypted to the memory controller 2c (processes T36 and T37). Accordingly, the encrypted data is written to the memory area 27 designated by the address. When the authentication fails, the monitoring device 26 inhibits writing of the encrypted data to the memory area 27 (see reference sign (IV) in FIG. 5).

On the other hand, in the storing (process T14 in FIG. 6), the address of the memory area 27 to be loaded is transmitted from the FPGA 21 to the memory area 27 (process T38). The FPGA 21 receives the encrypted data loaded from the memory area 27 (process T39) and decrypts the received encrypted data (process T40).

Returning to the description with reference to FIG. 6, when the calculation by the processing circuit 22 ends, the FPGA 21 transmits a calculation end message to the client machine 4 (process T15). Data of the calculation result (for example, encrypted data) stored in the memory area 27 is transmitted to the client machine 4 via the network devices 28 and 44 (process T16).

When the received data has been encrypted, the application 41 of the client machine 4 decrypts the encrypted data using the encryption key transmitted from the management machine 3 (process T17). When the process ends, the application 41 transmits a service end message to the management machine 3 (process T18) and the service using the FPGA 21 ends.

### [1-4] Example of Hardware Configuration

An example of hardware configurations of the host machine 2, the management machine 3, and the client machine 4 will be described below. The host machine 2, the management machine 3, and the client machine 4 may have the same hardware configuration. Hereinafter, for the purpose of convenience, the host machine 2, the management machine 3, and the client machine 4 are referred to as a computer 5 together and an example of a hardware configuration of the computer 5 will be described.

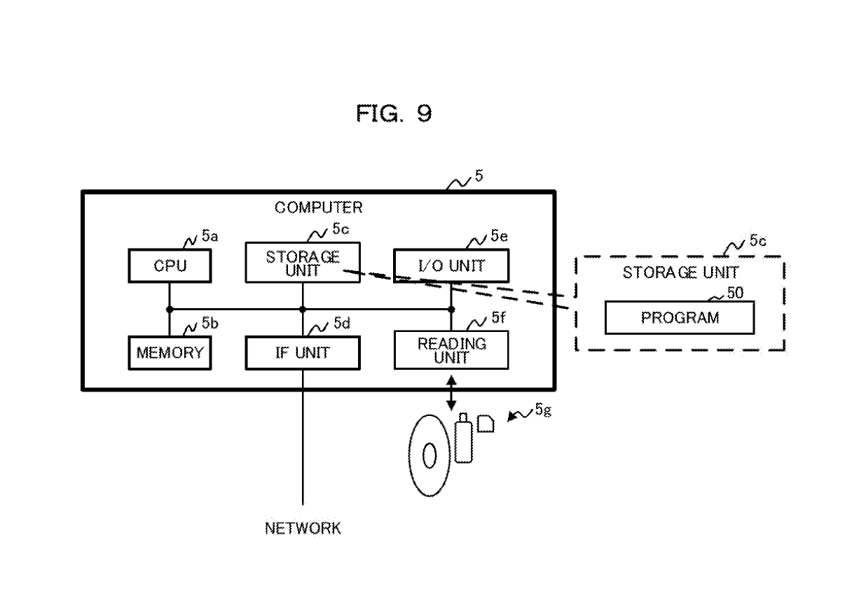

As illustrated in FIG. 9, the computer 5 may include, for example, a CPU 5a, a memory 5b, a storage unit 5c, an interface (IF) unit 5d, an input/output (I/O) unit 5e, and a reading unit 5f.

The CPU 5a is an example of a processor that performs variety of control or operations. The CPU 5a may be connected to blocks in the computer 5 to be communicable via a bus. As the processor, an electronic circuit, for example, an integrated circuit (IC) such as a micro processing unit (MPU) or an application specific integrated circuit (ASIC), may be used instead of an arithmetic processing device such as the CPU 5a.

The memory 5b is an example of hardware in which information such as a variety of data or programs is stored. An example of the memory 5b is a volatile memory such as a RAM.

The CPU 2a and the memory 2b of the host machine 2 illustrated in FIG. 5 are examples of the CPU 5a and the memory 5b illustrated in FIG. 9.

The storage unit 5c is an example of hardware in which information such as a variety of data or programs is stored. Examples of the storage unit 5c include various storage devices such as a magnetic disk device such as a hard disk drive (HDD), a semiconductor drive device such as a solid state drive (SSD), and a nonvolatile memory such as a flash memory or a read only memory (ROM).

For example, the storage unit 5c may store a program 50 for realizing all or a part of various functions of the computer 5. The CPU 5a can realize the functions of the computer 5, for example, by loading and executing the program 50 stored in the storage unit 5c into the memory 5b.

The IF unit 5d is an example of a communication interface that controls connection and communication with a network or the like. Examples of the IF unit 5d include adapters based on LAN, infiniband, fibre channel (FC), universal serial bus (USB), and Bluetooth (registered trademark). The network device 28 of the host machine 2 and the network device 44 of the client machine 4 which re illustrated in FIG. 5 are examples of the IF unit 5d illustrated in FIG. 9.

The program 50 may be downloaded from a network or the like to the computer 5 via the IF unit 5d.

The I/O unit 5e may include one or both of an input unit such as a mouse, a keyboard, or operational buttons and an output unit such as a display or a printer.

The reading unit 5f is an example of a reader that reads information of data or a program recorded on a recording medium 5g. The reading unit 5f may include a connecting terminal or device into which the recording medium 5g can be connected or inserted. Examples of the reading unit 5f include an adapter based on a USB or the like, a drive device that accesses a recording disk, and a card reader that accesses a flash memory such as an SD card. The program 50 may be stored in the recording medium 5g.

Examples of the recording medium 5g include a non-transitory recording medium such as a magneto-optical disc or a flash memory. Examples of the magneto-optical disc include a flexible disc, a compact disc (CD), a digital versatile disc (DVD), a blu-ray disc, and a holographic versatile disc (HVD). Examples of the flash memory include a USB memory or an SD card. Examples of the CD include a CD-ROM, a CD-R, and a CD-RW. Examples of the DVD include a DVD-ROM, a DVD-RAM, a DVD-R, a DVD-RW, a DVD+R, and a DVD+RW.

The above-mentioned hardware configuration of the computer 5 is exemplary. Accordingly, in the computer 5, an increase or decrease of hardware (for example, addition or deletion of an arbitrary block), division, synthesis in an arbitrary combination, addition or deletion of a bus, or the like may be appropriately carried out. The host machine 2, the management machine 3, and the client machine 4 may have different hardware configurations. In an example of the hardware configuration of the host machine 2, the FPGA 21 illustrated in FIG. 5 and a device or circuit related thereto may be additionally provided to the configuration illustrated in FIG. 9.

### [1-5] Example of Configuration of Host Machine

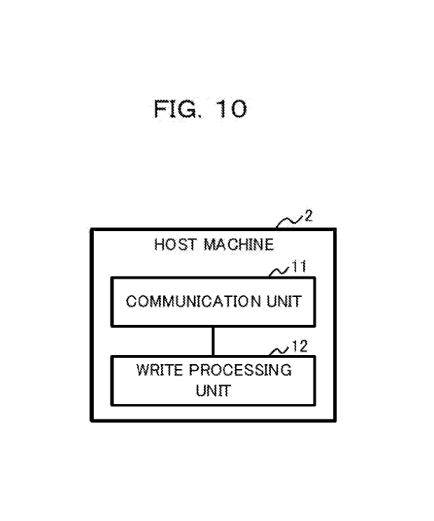

An example of a functional configuration of the host machine 2 according to the embodiment will be described below with reference to FIG. 10. As illustrated in FIG. 10, the host machine 2 may include, for example, a communication unit 11 and a write processing unit 12.

The communication unit 11 communicates with the management machine 3 and the client machine 4 via a network device 28 or via a communication line 1b illustrated in FIG. 5. The communication with the client machine 4 may include transmission and reception of a request or data related to implementation of the processing circuit 22. The communication with the management machine 3 may include transmission or reception of a request or data related to writing of the processing circuit 22, the generation unit 23, the encryption device 24, and the ID output unit 25 or transmission or reception of a request or data related to registration of information in the monitoring device 26.

The write processing unit 12 writes the logic to the FPGA 21 using a function of an OS or a driver. For example, the write processing unit 12 may write the logic of an accelerator to the FPGA 21 via the control line 29 illustrated in FIG. 5 based on an accelerator implementation instruction to the FPGA 21 from the management machine 3. In this case, the communication unit 11 may receive the accelerator implementation instruction from the management machine 3 and may transmit an accelerator implementation completion message to the management machine 3 when the write process by the write processing unit 12 is completed. When the management machine 3 performs these processes via the dedicated line 1a, the write processing unit 12 is unnecessary.

The logic synthesis of the accelerator may be performed by the write processing unit 12. In this case, the write processing unit 12 may acquire information of a process IP core, an encryption IP core, and an ID from the FPGA 21 via the communication unit 11.

The above-mentioned function of the host machine 2 may be realized by causing the CPU 5a of the host machine 2 (for example, the CPU 2a illustrated in FIG. 5) to execute the program 50 stored in the memory 5b (for example, the memory 2b illustrated in FIG. 5).

### [1-6] Example of Configuration of Management Machine

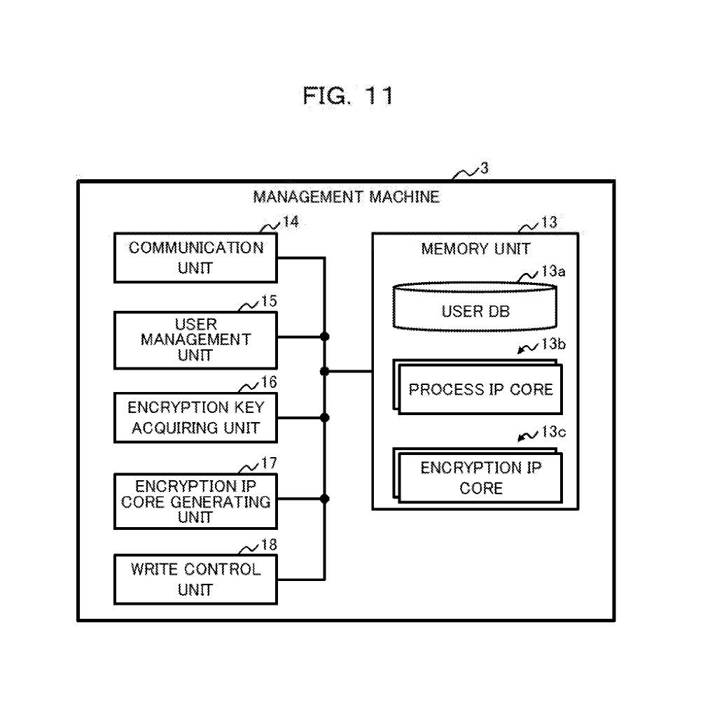

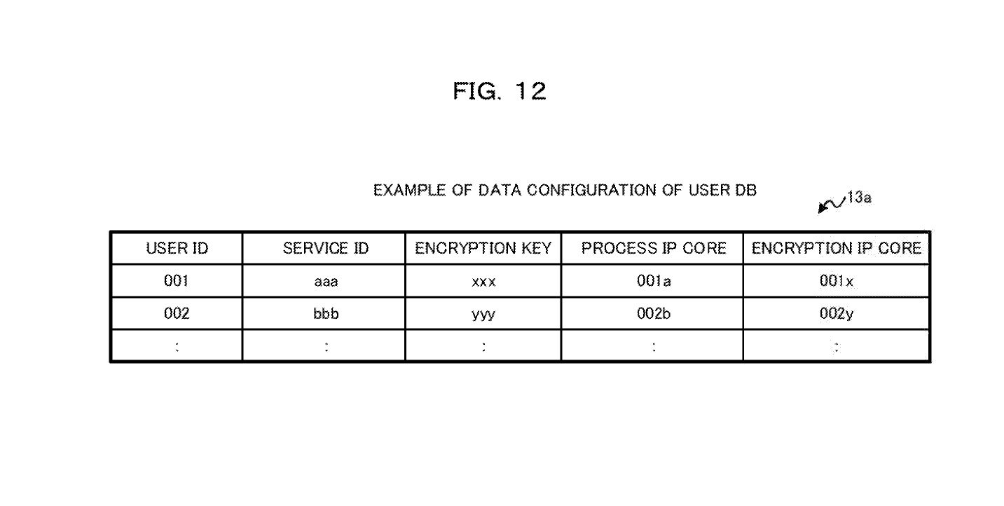

An example of a functional configuration of the management machine 3 according to the embodiment will be described below with reference to FIGS. 11 and 12.

As illustrated in FIG. 11, the management machine 3 may include, for example, a memory unit 13, a communication unit 14, a user management unit 15, an encryption key acquiring unit 16, an encryption IP core generating unit 17, and a write control unit 18.

The memory unit 13 may store a user database (DB) 13a, one or more process IP cores 13b, and one or more encryption IP cores 13c. The memory unit 13 may be realized, for example, by a storage area of the memory 2b illustrated in FIG. 5.

The communication unit 14 communicates with the host machine 2 and the client machine 4. The communication with the client machine 4 may include transmission or reception of information on providing a service, for example, user information, information on the logic of the accelerator, and information on an encryption key.

The user management unit 15 manages a user who uses a cloud service. For example, the user management unit 15 may manage a user, an ID, an IP core, and an encryption key in correlation with each other based on the user DB 13a. The user management unit 15 may perform authentication for a service request from the client machine 4, a process of managing the received IP core as the process IP core 13b or the encryption IP core 13c, update of the user DB, and the like.

The user DB 13a is an example of a database for managing information for each user. The user DB 13a may be realized, for example, by the memory 5b or the storage unit 5c (see FIG. 9). An example of a data configuration of the user DB is illustrated in FIG. 12.

As illustrated in FIG. 12, the user DB 13a may include information of user IDs, service IDs, encryption keys, process IP cores, and encryption IP cores. A user ID is an example of information for identifying the user, for example, the application 41, and a service ID is an example of information for identifying a service which is used by the user. As the service ID, for example, an ID of the processing circuit 22 or the circuit area allocated in the FPGA 21 or an ID of the accelerator may be used.

An encryption key may be information of the encryption key or may be information capable of specifying the encryption key acquired by the encryption key acquiring unit 16. A process IP core and an encryption IP core may be information of the IP core acquired by the user management unit 15 or the encryption IP core generating unit 17 or may be information capable of specifying the IP core.

The process IP core 13b is, for example, IP cores for configuring the processing circuit 22, the generation unit 23, and the ID output unit 25 which are received from the client machine 4.

The encryption IP core 13c are IP cores for configuring the encryption device 24, the selector 21c, and the like. The encryption IP core 13c may be, for example, information of the encryption IP core received from the client machine 4 or the encryption IP core generated by the encryption IP core generating unit 17 or information of an encryption IP core stored in advance.

The process IP core 13b and the encryption IP core 13c may be stored in the memory 5b, the storage unit 5c, or the like until the logic synthesis is performed. The IP cores are reusable functional blocks. Accordingly, when there is a possibility of reuse, one or both of the process IP core 13b and the encryption IP core 13c may be continuously stored, for example, in the memory 5b or the storage unit 5c even when the logic synthesis is performed.

The encryption key acquiring unit 16 acquires an encryption key which is used for encryption or decryption in the encryption device 24 and the monitoring device 26 or decryption in the client machine 4. In the acquiring of the encryption key, the encryption key in addition to the information of the encryption IP core 13c may be received from the client machine 4, or the encryption key may be generated by the encryption key acquiring unit 16 using an existing method. The generated encryption key may be stored in the memory 5b or the storage unit 5c, for example, until the logic synthesis is performed.

The encryption IP core generating unit 17 generates the encryption IP core 13c. For example, the encryption IP core generating unit 17 may generate the encryption IP core 13c including the encryption key acquired by the encryption key acquiring unit 16 as a key to encryption and may store the generated encryption IP core 13c in the memory 5b, the storage unit 5c, or the like. Alternatively, the encryption IP core generating unit 17 may set the encryption key acquired by the encryption key acquiring unit 16 as a key to encryption for the encryption IP core stored in advance in the memory or the like. When the encryption IP core 13c in which the key to encryption is set is transmitted from the client machine 4, the configuration of the encryption IP core generating unit 17 is unnecessary.

In other words, at least one of the user management unit 15 and the encryption IP core generating unit 17 is an example of an acquisition unit that acquires the first information and the second information. The communication unit 14 is an example of a reception unit that receives a request for instructing the processing circuit 22 to be configured in the FPGA 21 from the client machine 4.

The write control unit 18 performs logic synthesis of the process IP core 13b and the encryption IP core 13c and performs control of writing the processing circuit 22, the encryption device 24, the selector 21c, and the like to the FPGA 21. The write control unit 18 performs control of registering information of the encryption key and the ID for each processing circuit 22 and the management information on the monitoring device 26.

In other words, the write control unit 18 is an example of a control unit that performs control of configuring at least the processing circuit 22, the encryption device 24, and a MUX 216 on the FPGA 21 based on the process IP core and the encryption IP core. The write control unit 18 is an example of a registration unit that registers identification information allocated to the processing circuit 22 and information on the encryption key corresponding to the identification information in the monitoring device 26 when performing control of configuring the processing circuit 22.

The above-mentioned function of the management machine 3 may be realized by causing the CPU 5a (see FIG. 9) of the management machine 3 to execute the program 50 stored in the memory 5b.

### [1-7] Practical Examples

Practical examples of the information processing system 1 according to the embodiment will be described below.

### [1-7-1] Example of Configuration of Practical Example

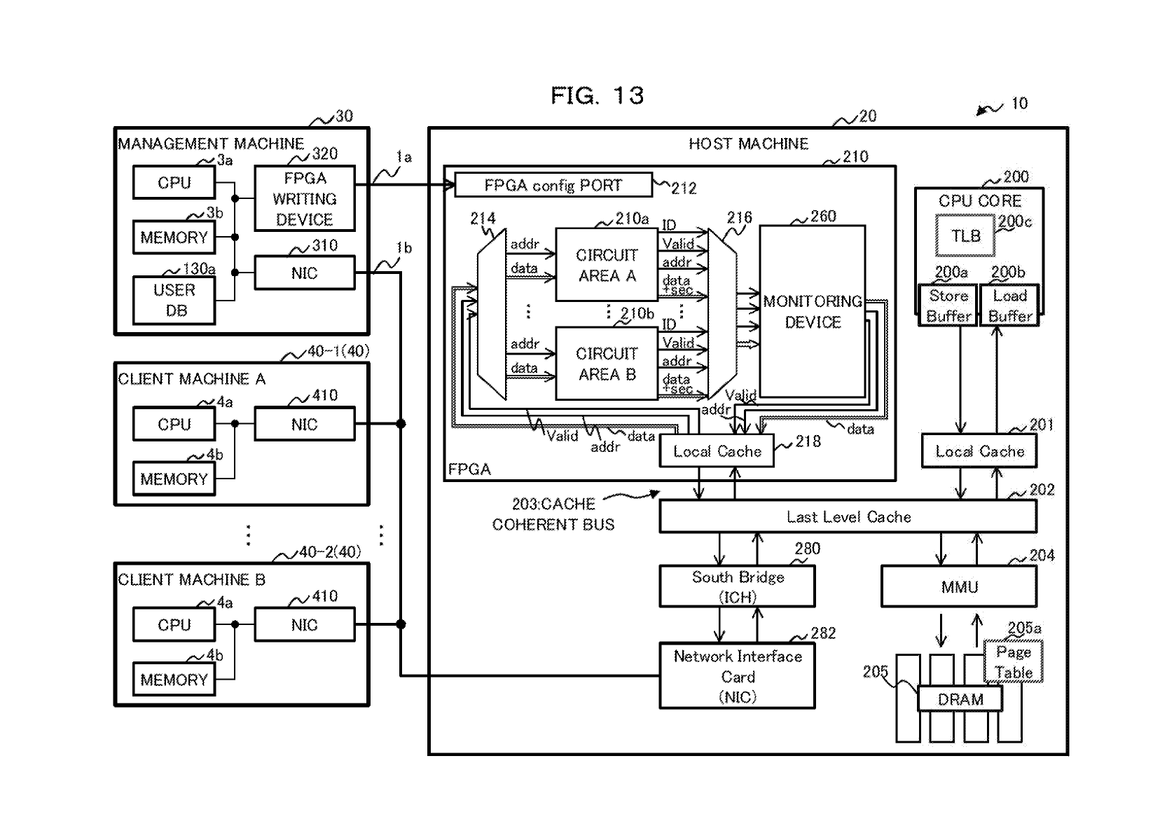

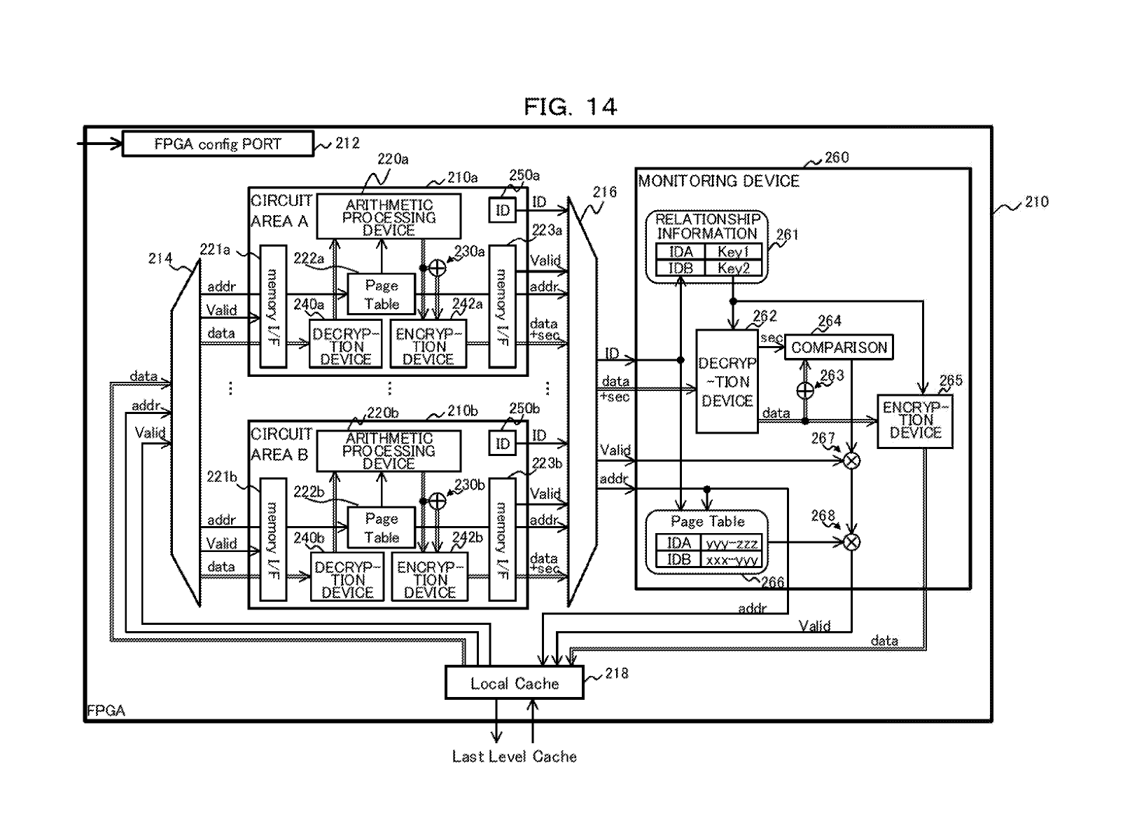

An example of a configuration of an information processing system 10 according to a practical example will be described below with reference to FIGS. 13 and 14. FIG. 13 is a block diagram illustrating a configuration of the information processing system 10 according to a practical example of the embodiment. FIG. 14 is a block diagram illustrating an example of a configuration of an FPGA 210 illustrated in FIG. 13.

As illustrated in FIG. 13, the information processing system 10 may include, for example, a host machine 20, a management machine 30, and a plurality of (two in the example illustrated in FIG. 13) client machines 40-1 and 40-2. A plurality of host machines 20 or a plurality of management machines 30 may be present in the information processing system 10, or three or more client machines 40 may be present in the information processing system 10.

The host machine 20 may include, for example, a CPU core 200, a local cache 201, a last level cache 202, a cache coherent bus 203, an MMU 204, and a dynamic RAM (DRAM) 205. The host machine 20 may include, for example, an FPGA 210, a south bridge 280, and a network interface card (NIC) 282. A plurality of CPU cores 200 or a plurality of FPGAs 210 may be present in the host machine 20.

The CPU core 200 may include a store buffer 200a, a load buffer 200b, and a TLB 200c. The store buffer 200a may be used as a buffer of data which is stored in a local cache 201, and the load buffer 200b may be used as a buffer of data which is loaded from the local cache 201. The TLB 200c may store some information in a page table 205a stored in the DRAM 205, for example, a conversion table of addresses which are frequently used.

The local cache 201 is a cache which is provided for each CPU core 200, and may be positioned, for example, as an L1 cache. The CPU core 200 and the local cache 201 are an example of the CPU 2a illustrated in FIG. 5.

The last level cache 202 is a cache which is disposed between the CPU core 200 and the FPGA 210 and the MMU 204, and may be positioned, for example, as a cache in a final stage. The last level cache 202 may provide a cache coherent bus 203 between the CPU core 200 and the FPGA 210. In other words, in the host machine 20, the CPU core 200 and the FPGA 210 are handled as equivalent processors.

The MMU 204 processes a memory access which is requested by the CPU core 200 or the FPGA 210. The MMU 204 may have functions of controlling the cache, adjusting the bus, and the like. The MMU 204 is an example of the memory controller 2c illustrated in FIG. 5.

The DRAM 205 is a memory that serves as a main storage device of the host machine 20. For example, the DRAM 205 may be a memory module having a plurality of DRAM chips mounted thereon, for example, a dual inline memory module (DIMM). An example in which the DRAM 205 includes four DIMMs is illustrated in FIG. 13. The DRAM 205 is an example of the memory 2b illustrated in FIG. 5.

The DRAM 205 may store the page table 205a which is used by the OS of the host machine 20. The page table 205a is an example of information for managing allocation of a memory.

The FPGA 210 is an example of the FPGA 21 illustrated in FIG. 5. The FPGA 210 may include, for example, a plurality of (two in the example illustrated in FIG. 13) circuit areas 210a and 210b, an FPGA configuration port 212, a demultiplexer (DEMUX) 214, a MUX 216, a local cache 218, and a monitoring device 260.

A logic circuit which is used by a user of the client machine 40-1 and a logical circuit which is used by a user of the client machine 40-2 are configured in the circuit areas 210a and 210b, respectively. Details of the circuit areas 210a and 210b will be described later.

The FPGA configuration port 212 is a port which is used to configure a logical circuit in the FPGA 210. The management machine 30 can configure a logic circuit in the FPGA 210 by accessing the FPGA configuration port 212 via the dedicated line 1a.

The DEMUX 214 is a circuit that distributes an input signal to any one of a plurality of outputs. For example, DEMUX 214 outputs information of an address, data, and a Valid input from the local cache 218 to any one of the circuit areas 210a and 210b. No address line may be present on an input side to the FPGA 210. The Valid is a signal indicating which data of timing from the DRAM 205 is valid.

The MUX 216 is a circuit that selects one of a plurality of inputs and outputs the selected signal and is an example of the selector 21c illustrated in FIG. 5. For example, the MUX 216 selects information of an ID, an address, data, and a Valid input from the circuit area 210a or information of an ID, an address, data, and a Valid input from the circuit area 210b, and outputs the selected information to the monitoring device 26.

As the Valid on the output side of the FPGA 210, a command which is a signal indicating which of a reading process and a writing process is requested by the circuit area 210a or 210b may be used. For example, a state in which the command indicates a writing process may be handled as a state in which the Valid is valid (for example, an asserted state). An address and data which are input at the timing at which the Valid is asserted are valid as a memory request.

The monitoring device 260 is an example of the monitoring device 26 illustrated in FIG. 5. The monitoring device 260 authenticates an address and data based on an ID, the address, the data, and the Valid input from the MUX 216. When the authentication succeeds, the monitoring device 260 outputs the ID, the address, the data, and the Valid to the local cache 218. On the other hand, when the authentication fails, the monitoring device 260 inhibits the memory access by deasserting and invalidating the Valid and stopping outputting of the address and the data from the local cache 218

The local cache 218 is a cache which is provided for each FPGA 210. The local cache 218 in addition to the local cache 201 may be connected to the cache coherent bus 203. When the Valid is valid, the local cache 218 outputs the input address and the input data to the last level cache 202.

The south bridge 280 is an example of the integrated circuit (IC) including a chip set serving as a peripheral circuit of the processor. In the example illustrated in FIG. 13, the south bridge 280 is a controller that controls a peripheral device such as the NIC 282. An example of the south bridge 280 is an I/O controller hub (ICH).

The NIC 282 is a device that connects the host machine 20 to a network such as a LAN. The NIC 282 is an example of the network device 28 illustrated in FIG. 5. For example, the NIC 282 may be connected to the management machine 30 and the client machine 40 in a wired or wireless manner.

The management machine 30 includes, for example, a CPU 3a, a memory 3b, an NIC 310, an FPGA writing device 320, and a user DB 130a.

The CPU 3a and the memory 3b are examples of the CPU 5a and the memory 5b illustrated in FIG. 9. The user DB 130a is an example of a database for managing information for each user and may have the same data configuration as the user DB 13a illustrated in FIG. 11.

The NIC 310 is a device that connects the management machine 30 to a network such as a LAN. For example, the NIC 310 may be connected to the host machine 20 and the client machine 40 in a wired or wireless manner. The management machine 30 may instruct the OS which is executed by the CPU core 200 of the host machine 20 to implement an accelerator in the FPGA 210 via a communication line 1b using the NIC 310.

The FPGA writing device 320 performs control of writing an accelerator to the circuit area 210a or 210b of the FPGA 210 on the FPGA configuration port 212 disposed in the FPGA 210 of the host machine 20 via a dedicated line 1a. The writing of an accelerator to the FPGA 210 can be realized using various existing methods.

The client machine 40 includes, for example, a CPU 4a, a memory 4b, and an NIC 410.

The CPU 4a and the memory 4b are examples of the CPU 5a and the memory 5b illustrated in FIG. 9.

The NIC 410 is a device that connects the client machine 40 to a network such as a LAN. For example, the NIC 410 may be connected to the host machine 20 and the management machine 30 in a wired or wireless manner.

An example of configurations of the FPGA 210 and the monitoring device 260 of the host machine 20 will be described below with reference to FIG. 14.

For example, an arithmetic processing device 220, memory I/Fs 221 and 223, a generation unit 230, a decryption device 240, an encryption device 242, and an ID output unit 250 may be configured in each of the circuit area 210a and 210b. For example, a storage element that stores information of a page table 222 may be configured in the circuit areas 210a and 210b.

The arithmetic processing device 220 is an example of the processing circuit 22 illustrated in FIG. 5. The arithmetic processing device 220 may include logic which is designed by a corresponding user or the like. The arithmetic processing device 220 may execute an OS as a processor in addition to the CPU core 200.

The memory I/Fs 221 and 223 provide an interface for the DRAM 205. The memory I/Fs 221 and 223 may be constituted by a process IP core.

When the Valid is valid, the memory I/F 221 outputs an address and data from the DRAM 205, which have been received from DEMUX 214, to the page table 222 and the decryption device 240. The memory I/F 223 outputs an address output from (passing through) the page table 222, data output from the encryption device 242, and the Valid to the MUX 216.

The page table 222 is used for conversion between a virtual address and a physical address by the arithmetic processing device 220. For example, the arithmetic processing device 220 or the management machine 30 may copy the page table 205a stored in the DRAM 205 and store the copied page table 205a in the page table 222. The page table 222 is an example of the management information for managing addresses of the DRAM 205.

The generation unit 230 is an example of the generation unit 23 illustrated in FIG. 5. The generation unit 230 generates a checksum of data of the calculation results output from the arithmetic processing device 220 and outputs the generated checksum to the encryption device 242.

The decryption device 240 decrypts encrypted data input from the memory I/F 221 using an encryption key correlated with the arithmetic processing device 220 and outputs the decrypted data to the arithmetic processing device 220. The encryption device 242 encrypts the data output from the arithmetic processing device 220 and the checksum (sec) output from the generation unit 230 using the encryption key correlated with the arithmetic processing device 220 and outputs the encrypted data to the memory I/F 223. In other words, the decryption device 240 and the encryption device 242 are examples of the encryption device 24 illustrated in FIG. 5.

The ID output unit 250 is an example of the ID output unit 25 illustrated in FIG. 5. In the ID output unit 250, an ID of the circuit area 210a or 210b or the arithmetic processing device 220 is set. The ID output unit 250 outputs the set ID to the MUX 216.

The monitoring device 260 may include, for example, a decryption device 262, a generation unit 263, a comparison unit 264, an encryption device 265, a first AND operation unit 267, and a second AND operation unit 268. In the monitoring device 260, for example, a storage element that stores relationship information 261 and information of a page table 266 may be configured.

The relationship information 261 is information for managing the correlation between an ID allocated to the arithmetic processing device 220 and an encryption key corresponding to the ID. The monitoring device 260 acquires the encryption key corresponding to the ID received from the MUX 216 from the relationship information 261 and outputs the acquired encryption key to the decryption device 262 and the encryption device 265.

The decryption device 262 decrypts the encrypted data of the data and the sec received from the MUX 216 using the encryption key acquired from the relationship information 261, outputs the decrypted data to the generation unit 263 and the encryption device 265, and outputs the decrypted sec to the comparison unit 264.

The generation unit 263 generates the sec from the data input from the decryption device 262 and outputs the generated sec to the comparison unit 264.

The comparison unit 264 compares the sec input from the generation unit 263 with the sec input from the decryption device 262, and outputs a signal indicating validity when both coincides with each other and indicating invalidity when both do not coincide with each other to the first AND operation unit 267. For example, the comparison unit 264 may control a signal line connected to the first AND operation unit 267 to be asserted when it is valid and to be deasserted when it is invalid, similarly to the Valid.

The encryption device 265 encrypts the data input from the decryption device 262 using the encryption key acquired from the relationship information 261 and outputs the encrypted data to the local cache 218.

The page table 266 is information for managing the ID allocated to the arithmetic processing device 220 and an address range of the storage area of the DRAM 205 allocated to the arithmetic processing device 220.

The monitoring device 260 compares the address of the access destination received from the MUX 216 with the address range which is managed in the page table 266 and corresponds to the ID received from the MUX 216. The monitoring device 260 outputs a signal indicating validity when both coincides with each other and indicating invalidity when both do not coincide with each other to the second AND operation unit 268. For example, the monitoring device 260 may control a signal line between the page table 266 and the second AND operation unit 268 to be asserted when it is valid and to be deasserted when it is invalid, similarly to the Valid.

The first AND operation unit 267 performs an AND operation of the Valid received from the MUX 216 and the output from the comparison unit 264 and outputs the operation result to the second AND operation unit 268. For example, the first AND operation unit 267 may output a signal indicating validity to the second AND operation unit 268 when both of the Valid received from the MUX 216 and the output signal from the comparison unit 264 indicate validity (when both are asserted).

The second AND operation unit 268 performs an AND operation of the output from the first AND operation unit 267 and the comparison result with the page table 266 and outputs the operation result as a Valid to the local cache 218. For example, the second AND operation unit 268 may assert and invalidate the Valid on the output side when both of the output signal from the first AND operation unit 267 and the comparison result with the page table 266 are valid (when both are asserted).

The first AND operation unit 267 and the second AND operation unit 268 may be constituted by a single AND operation unit.

As described above, the process using the relationship information 261, the decryption device 262, the generation unit 263, the comparison unit 264, and the first AND operation unit 267 in the monitoring device 260 is an example of the authentication process on an ID and data. The process using the relationship information 261 and the second AND operation unit 268 in the monitoring device 260 is an example of the authentication process on an address.

### [1-7-2] Example of Operation of Practical Example

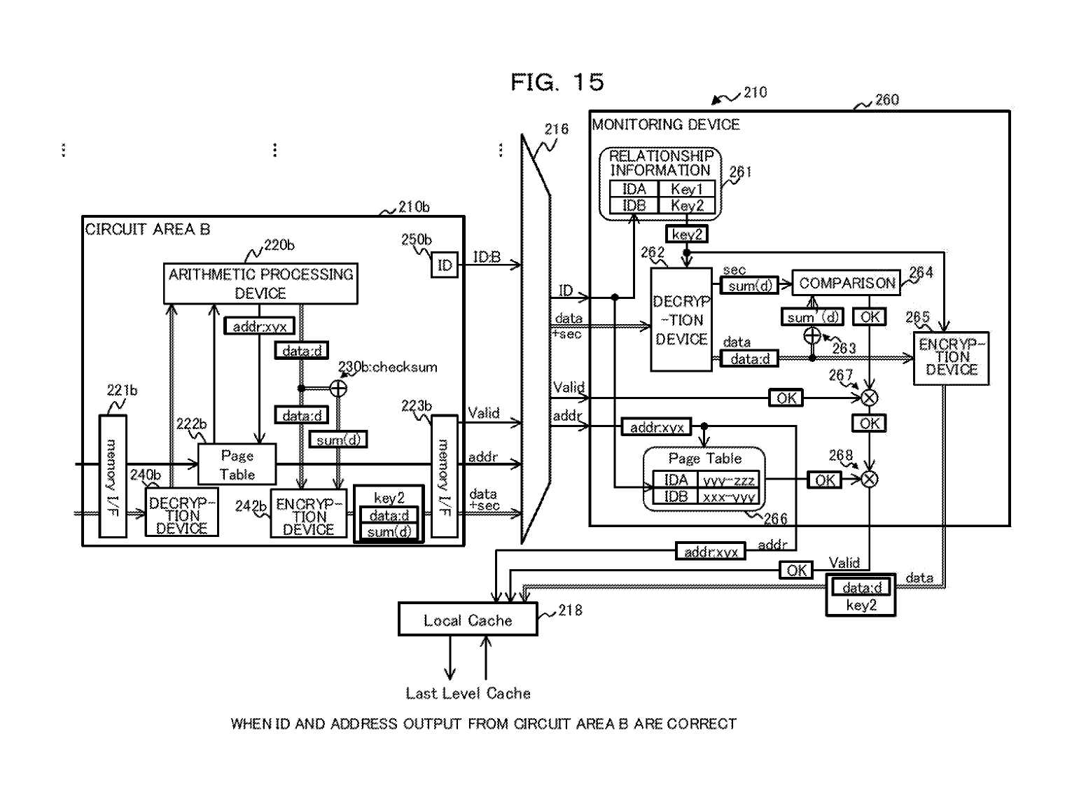

An example of an operation in the FPGA 210 according to the practical example will be described below with reference to FIGS. 15 to 18. FIGS. 15 to 18 are diagrams illustrating an example of an operation of the FPGA 210 based on an ID and an address output from the circuit area 210b. In the following description, some configurations will not be made for the purpose of simplification of illustration.

(Case in which ID and Address Output from Circuit Area 210b are True)

As illustrated in FIG. 15, an arithmetic processing device 220b outputs a true address “addr:xyx” of the DRAM 205 allocated to the circuit area 210b as an address of an access destination to the memory I/F 223.

An encryption device 242b encrypts data “data:d” output from the arithmetic processing device 220b and a checksum “sum(d)” generated based on the data “data:d” by the generation unit 230b using an encryption key “key2” and outputs the encryption result to the memory I/F 223.

The memory I/F 223b validates the Valid and outputs “addr:xyx” from the arithmetic processing device 220b and the encrypted data from the encryption device 242b to the MUX 216.

An ID output unit 250b outputs a true ID “ID:B” allocated to the circuit area 210b as an ID to the MUX 216.

The monitoring device 260 reads “key2” corresponding to “ID:B” received from the MUX 216 from the relationship information 261 and outputs the read encryption key to the decryption device 262 and the encryption device 265.

The decryption device 262 decrypts the encrypted data received from the MUX 216 using “key2” and outputs the decryption results “data:d” and “sum(d).” The encryption device 265 encrypts the decrypted result “data:d” using “key2” and outputs the encryption result to the local cache 218.

The generation unit 263 generates a checksum “sum′(d)” from the decryption result “data:d.” Since the decryption result “sum(d)” coincides with “sum′(d)” from the generation unit 263, the comparison unit 264 outputs “OK” (valid).

The first AND operation unit 267 outputs an AND operation result “OK” of the Valid “OK” received from the MUX 216 and “OK” from the comparison unit 264.

The monitoring device 260 compares “addr:xyx” received from the MUX 216 with the address range “xxx-yyy” in the page table 266 corresponding to “ID:B” received from the MUX 216. Since an address coinciding with “addr:xyx” is present in the address range, the monitoring device 260 outputs “OK.” In addition, “addr:xyx” is output to the local cache 218.

The second AND operation unit 268 outputs an AND operation result “OK” of “OK” from the first AND operation unit 267 and the address comparison result “OK” as the Valid to the local cache 218.

Since the Valid is “OK,” “addr:xyx” and “data:d” are output from the local cache 218 to the cache coherent bus 203. Accordingly, “data:d” decrypted using “key2” is written to “addr:xyx” of the DRAM 205.

When encrypted data is read by the arithmetic processing device 220b, the decryption device 240b can correctly decrypt “data:d” using “key2.”

(Case in which ID Output from Circuit Area 210b is not True)

For example, a malicious IP is configured in the circuit area 210b, it is supposed that the malicious IP falsifies the ID output from the ID output unit 250b and impersonates another circuit area to perform memory access. Hereinafter, a case in which the ID output unit 250b outputs “ID:A” of the circuit area 210a will be considered.

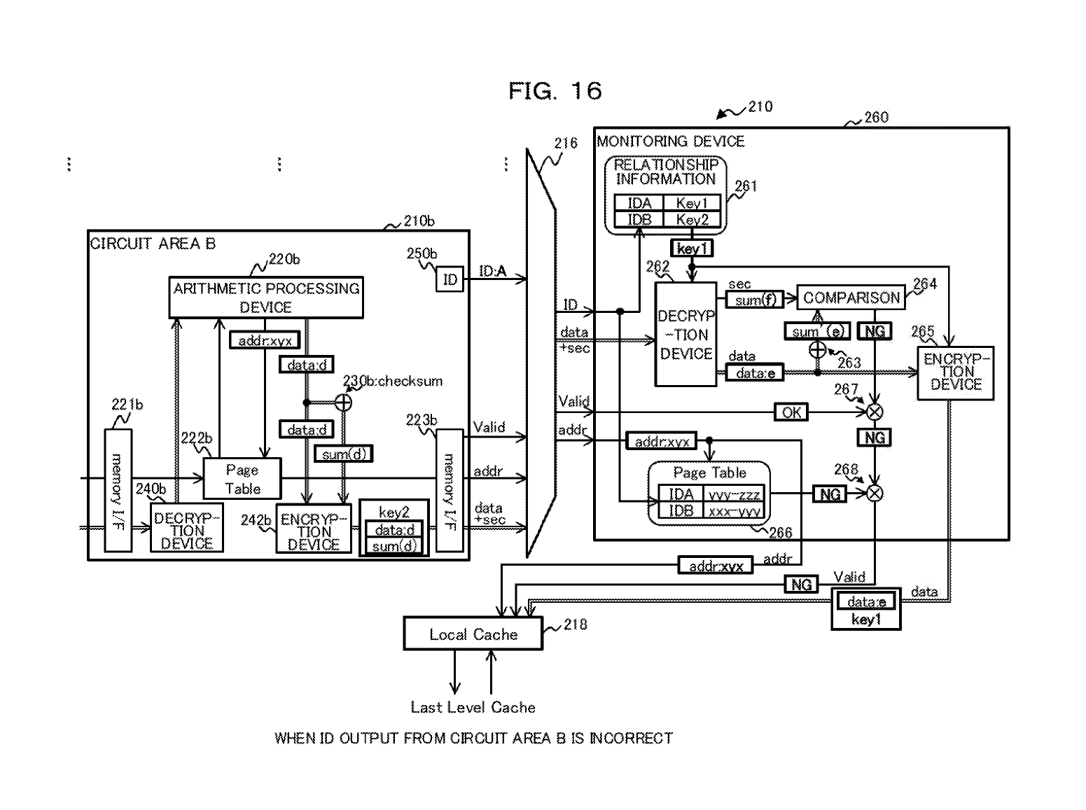

As illustrated in FIG. 16, when the ID output unit 250b outputs “ID:A” to the MUX 216, the monitoring device 260 reads “key1” corresponding to “ID:A” from the relationship information 261 and outputs “key1” to the decryption device 262 and the encryption device 265.

The decryption device 262 decrypts encrypted data received from the MUX 216 using “key1” but the encrypted data is encrypted using “key2.” Accordingly, “data:e” different from “data:d” and “sum(f)” different from “sum(d)” are output as the decryption result. The encryption device 265 encrypts the decryption result “data:e” using “key1” and outputs the encryption result to the local cache 218.

The generation unit 263 generates a checksum “sum′(e)” from the decryption result “data:e.” Since “sum(f)” and “sum′(e)” do not coincide with each other, the comparison unit 264 outputs “NG” (invalid).

The first AND operation unit 267 outputs an AND operation result “NG” of the Valid “OK” received from the MUX 216 and “NG” from the comparison unit 264.

The monitoring device 260 compares “addr:xyx” received from the MUX 216 with an address range “yyy-zzz” in the page table 266 corresponding to “ID:A” received from the MUX 216. Since an address coinciding with “addr:xyx” is not present in the address range, the monitoring device 260 outputs “NG.” In addition, “addr:xyx” is output to the local cache 218.

The second AND operation unit 268 outputs an AND operation result “NG” of “NG” from the first AND operation unit 267 and the address comparison result “NG” as a Valid to the local cache 218.

Since the Valid is “NG,” “addr:xyx” and “data:e” are not output from the local cache 218 to the cache coherent bus 203. Accordingly, “data:e” encrypted using “key1” is not written to “addr:xyx” of the DRAM 205.

(Case in which Address Output from Circuit Area 210b is not True)

As another example, it is supposed that a malicious IP falsifies an address of an access destination output from the arithmetic processing device 220b and accesses a storage area in the DRAM 205 allocated to another arithmetic processing device 220.

For example, the arithmetic processing device 220b may set an address other than an address determined in advance exclusively from the address determined in the page table 222a of the circuit area 210a for the page table 222b of the circuit area 210b. The “other address” is an address overlapping the address determined in the page table 222a of the circuit area 210a, for example, due to the malicious IP.

Alternatively, the address in the page table 222b of the circuit area 210b is true (exclusive from the address in the page table 222a of the circuit area 210a), but the address after being read may be converted into the “other address.”

Hereinafter, it is supposed that the arithmetic processing device 220b outputs “addr:yzy” allocated to the arithmetic processing device 220a as an access destination.

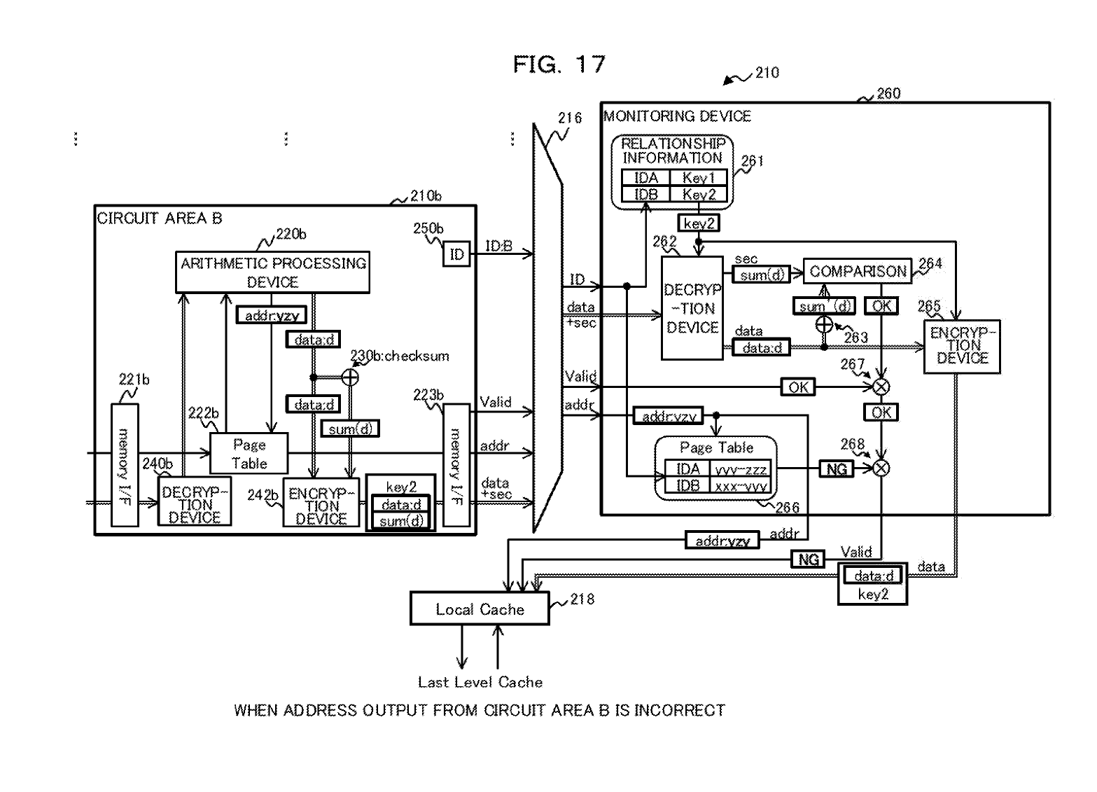

As illustrated in FIG. 17, when the arithmetic processing device 220b outputs “addr:yzy” to the memory I/F 223, the monitoring device 260 refers to an address range “xxx-yyy” in the page table 266 corresponding to “ID:B” received from the MUX 216. Then, the monitoring device 260 compares “addr:yzy” received from the MUX 216 with the address range “xxx-yyy,” but outputs “NG” because an address coinciding with “addr:yzy” is not present in the address range. In addition, “addr:yzy” is output to the local cache 218.

In this case, since “ID:B” is true, the process of authenticating data succeeds (the output from the first AND operation unit 267 is “OK”).

The second AND operation unit 268 outputs an AND operation result “NG” of “OK” from the first AND operation unit 267 and the address comparison result “NG” as a Valid to the local cache 218.

Since the Valid is “NG,” “addr:yzy” and “data:d” are not output from the local cache 218 to the cache coherent bus 203. Accordingly, “data:d” decrypted using “key2” is not written to “addr:yzy” of the DRAM 205.

(Case in which ID and Address Output from Circuit Area 210b are not True)

As another example, it is supposed that a malicious IP falsifies both an ID and an address and impersonates another arithmetic processing device 220 to perform a memory access. Hereinafter, a case in which a malicious IP outputs “ID:A” and “addr:yzy” allocated to the arithmetic processing device 220a will be considered.

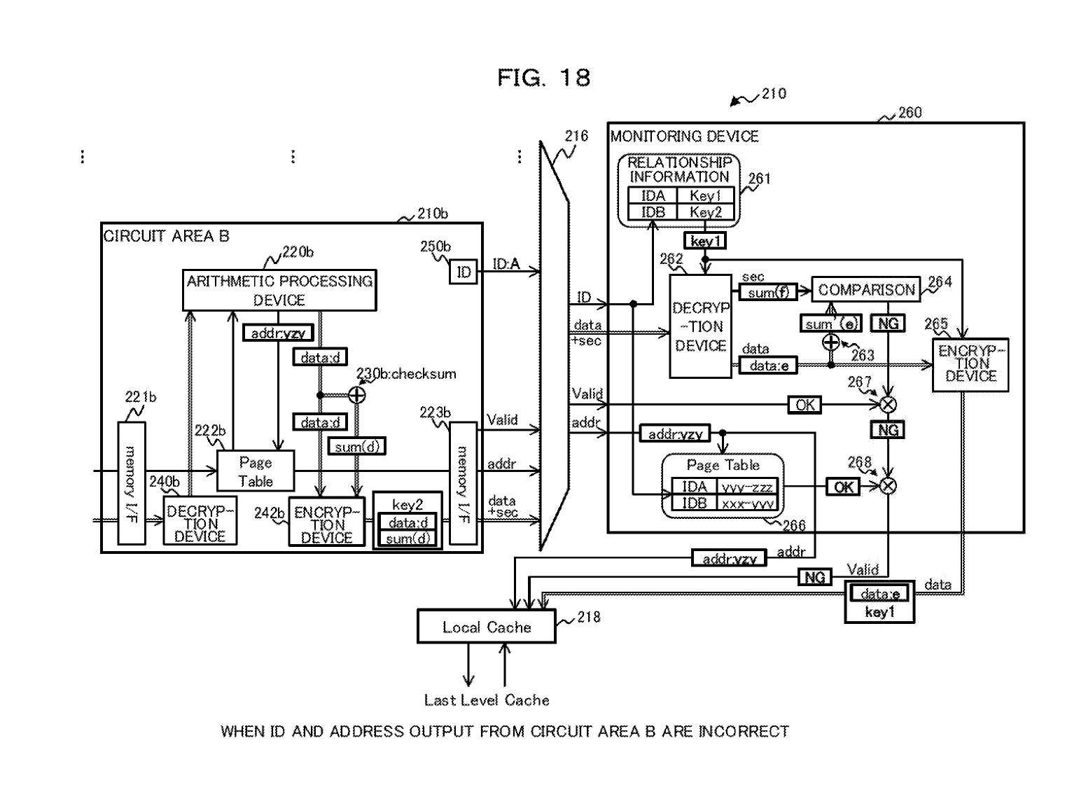

As illustrated in FIG. 18, in the process of authenticating an address, the monitoring device 260 refers to an address range “yyy-zzz” in the page table 266 corresponding to “ID:A” received from the MUX 216. The monitoring device 260 compares “addr:yzy” received from the MUX 216 with the address range “yyy-zzz.” Since an address coinciding with “addr:yzy” is present in the address range, the monitoring device 260 outputs “OK.” “addr:yzy” is output to the local cache 218.

In this way, when the malicious IP outputs the ID and the address allocated to the arithmetic processing device 220a, the result of the address authentication process is “OK.”

However, in authenticating the ID and data, as illustrated in FIG. 16, encrypted data encrypted using “key2” by the encryption device 242b is decrypted by the decryption device 262 using “key1.” Accordingly, an incorrect decryption result is acquired from the decryption device 262, “NG” is output from the comparison unit 264, and the final Valid output to the local cache 218 is “NG.”

In the local cache 218, since the Valid is “NG,” “addr:yzy” and “data:e” are not output to the cache coherent bus 203. Accordingly, “data:e” encrypted using “key1” is not written to “addr:yzy” of the DRAM 205.

As described above, according to the information processing system 1 or 10, in the host machine 20, it is possible to prevent a malicious IP from performing an unauthorized writing access to a storage area of the memory area 27 of another user. Accordingly, it is possible to prevent data of another user from being falsified by the malicious IP. As a result, for example, it is possible to prevent a threat that personal data stored in a cloud is illegally operated in advance. Since an unauthorized program for transmitting information to the outside can be prevented from being written to the memory area 27 of another user, it is possible to prevent a threat of information leakage in advance.

Data stored in the memory area 27 is data which is encrypted using an encryption key corresponding to the processing circuit 22a that can access the memory area 27. Accordingly, even when a user who uses another processing circuit 22b can acquire the encrypted data, the user does not have an appropriate encryption key and thus it is not possible to decrypt the encrypted data.

Accordingly, it is possible to prevent a malicious IP from stealing a glance at data from a storage area of a memory area 27 of another user and to prevent a threat of information leakage in advance. Examples of the threat of information leakage include a threat that accounting information before being published is stolen and stock prices are illegally manipulated, and a threat that a number of a credit card is stolen and is illegally used.

Accordingly, according to the information processing system 1 or 10 according to the embodiment, it is possible to realize data management of user data with high reliability.

In the information processing system 1 or 10 according to the embodiment, a generation unit 23, an encryption device 24, or the like is added to the FPGA 21 and a monitoring device 26 is added to the inside or outside of the FPGA 21. However, it is possible to suppress an increase in utilization cost of the FPGA 21 due to the added circuits, for example, circuit scale. In the information processing system 1, a time delay may occur due to processes such as encryption, decryption, authentication, and the like by hardware such as the generation unit 23, the encryption device 24, and the monitoring device 26. However, since the processes of the FPGA 21 are pipelined, it is possible to maintain a band.

As a technique of reducing a security risk in the information processing apparatus including the FPGA, a technique of causing the management device to determine whether received logic is a malicious algorithm can be considered. However, it may be difficult to perform the determination and it is impossible to say to completely prevent data falsification or data leakage by a malicious IP.

As another technique, a technique of adding hardware for monitoring the FPGA to the information processing apparatus can also be considered, but a memory access of a processor may often cause a bottle neck. Accordingly, there is a high possibility of performance deterioration or an increase in hardware cost and it is difficult to say to cause good cost effectiveness.

As a result, the above-mentioned technique according to the embodiment can be said to be effective as the technique of reducing a security risk in the information processing apparatus including the FPGA.

### [1-7-3] Modified Example of Practical Example

The circuit areas 210a and 210b or the monitoring device 260 illustrated in FIG. 14 may be configured as follows.

### [1-7-3-1] First Modified Example of Practical Example

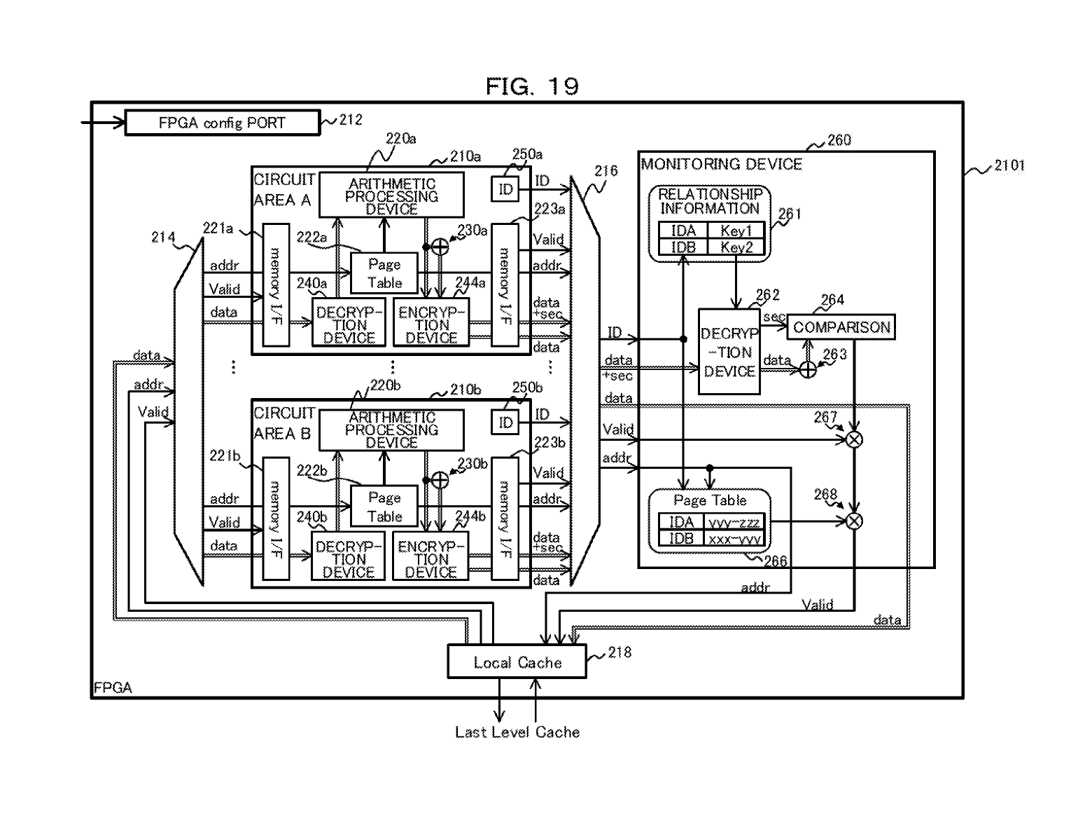

For example, as illustrated in FIG. 19, in an FPGA 2101 according to the first modified example of the practical example, each of the circuit areas 210a and 210b may include an encryption device 244 instead of the encryption device 242.

The encryption device 244 may output writing encrypted data which is obtained by encrypting the operation result of the arithmetic processing device 220 using an encryption key in addition to the encrypted data output from the encryption device 242. The writing encrypted data is transmitted to the monitoring device 260 via the memory I/F 223 and the MUX 216.

The monitoring device 260 may output the writing encrypted data to the local cache 218. Accordingly, the configuration of the encryption device 265 illustrated in FIG. 16 can be deleted from the monitoring device 260.

In this case, encrypted data of data and sec may be handled as data for an authentication process by the decryption device 262, the generation unit 263, and the comparison unit 264, and data decrypted by the decryption device 262 may be read and discarded after being used to generation of sec by the generation unit 263.

According to this configuration, the same advantages as in the practical example can be achieved. Since the encryption device 265 is unnecessary for the monitoring device 260, it is possible to reduce the circuit scale (cost) of the monitoring device 260.

### [1-7-3-2] Second Modified Example of Practical Example

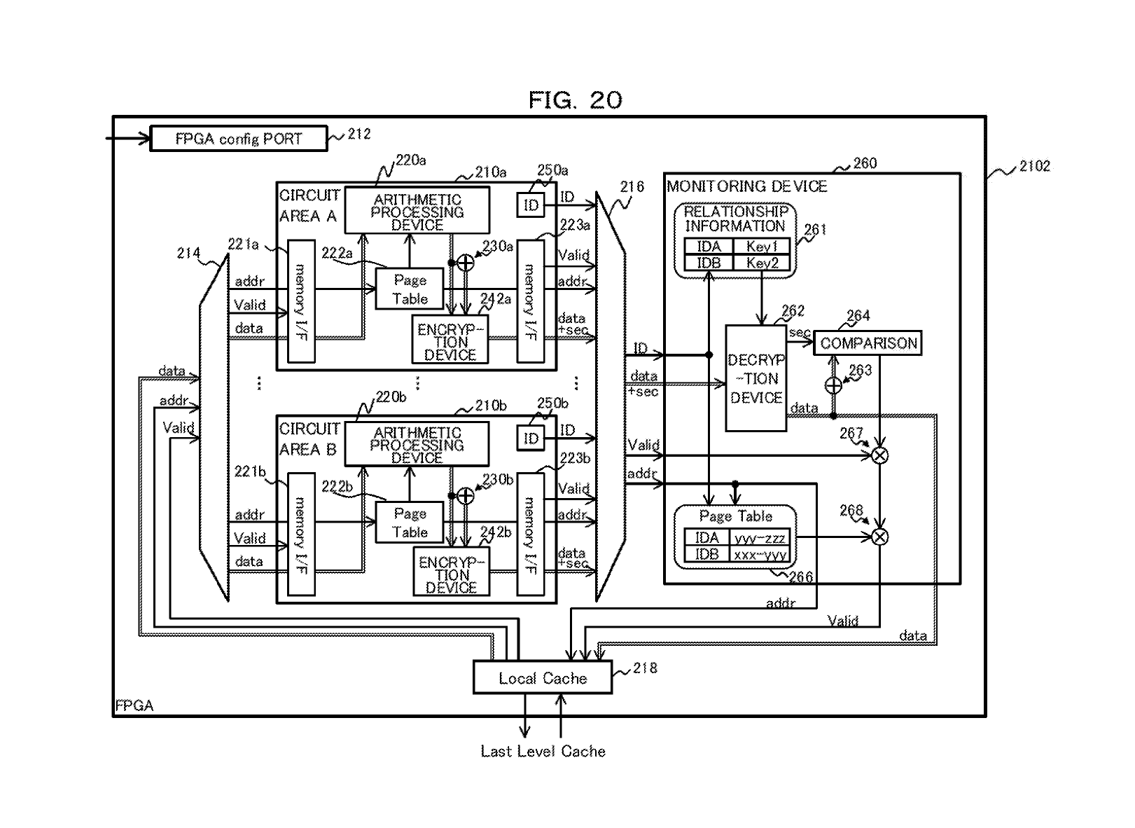

Data which is written to the DRAM 205 may be non-encrypted data (plain text). As illustrated in FIG. 20, in an FPGA 2102 according to the second modified example of the practical example, the configuration of the decryption device 240 (see FIG. 14) may be deleted from each of the circuit areas 210a and 210b. The configuration of the encryption device 265 (see FIG. 16) may be deleted from the monitoring device 260.

Accordingly, data (plain text) decrypted by the decryption device 262 is output in the local cache 218.

According to this configuration, it is possible to prevent at least falsification of data in the memory area 27 or the DRAM 205 of another user by a malicious IP. Since the decryption device 240 is unnecessary for the circuit areas 210a and 210b and the encryption device 265 is unnecessary for the monitoring device 260, it is possible to reduce the circuit scale (cost) of the FPGA 2102 as a whole.

As described above, according to the technique according to the embodiment, in the information processing system 10 illustrated in FIGS. 13 to 20, it is also possible to prevent data falsification or data leakage and to reduce a security risk.

### [1-8] Modified Example

A modified example of the embodiment will be described below.

In the embodiment, the management machine 3 receives an IP core prepared by a user from the client machine 4 and configures a processing circuit 22 in the FPGA 21 based on the IP core.

As described above, an IP is a functional block which is reusable. In a service using an FPGA, since an IP can be reused, an IP which was designed in the past by a certain user may be reused by the user or another user for each functional block or a functional block may be prepared and sold.

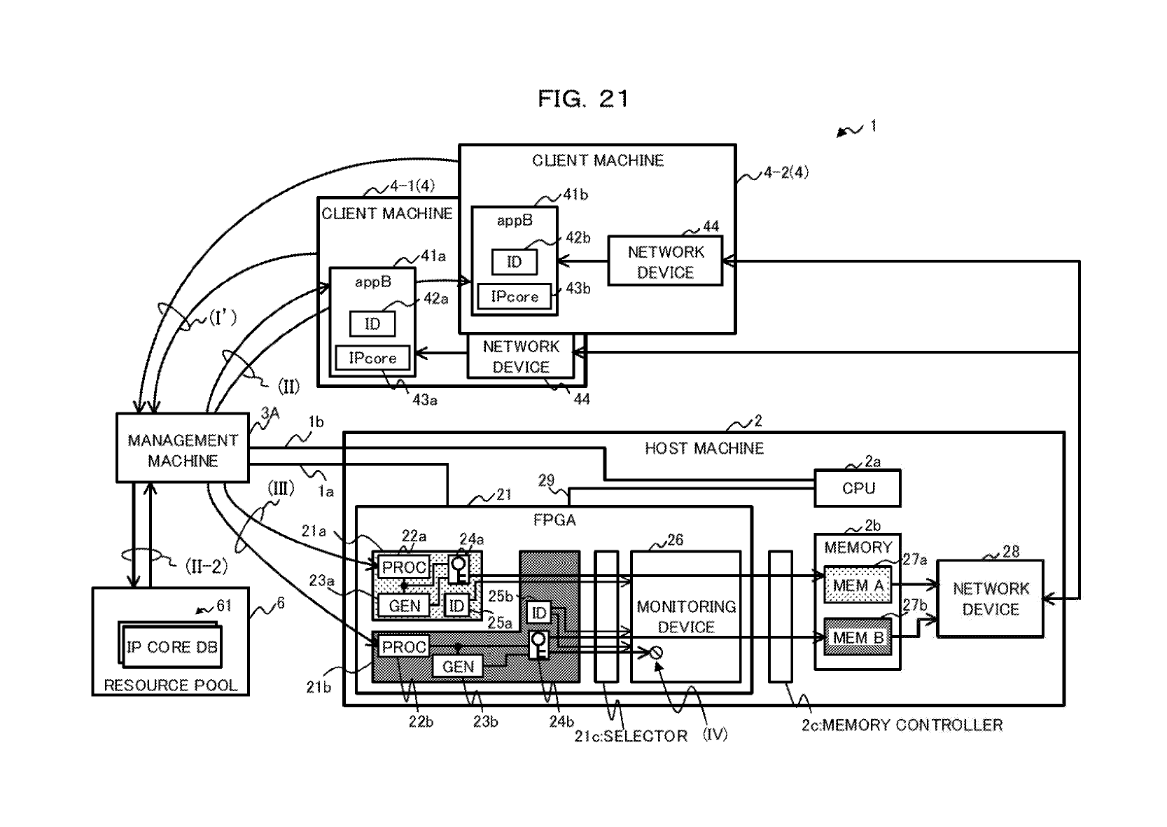

Therefore, in a modified example of the embodiment, an information processing system 1A may include a resource pool 6 of IP cores as illustrated in FIG. 21. The information processing system 1A may include the same host machine 2 and client machine 4 as in the information processing system 1 illustrated in FIG. 5 or may include a management machine 3A having functions partially different from those of the information processing system 1.

The resource pool 6 is an example of a storage device that stores a plurality of IP cores, that is, a plurality of pieces of first information corresponding to a plurality of types of processing circuits 22. The resource pool 6 may further store second information which is used to configure the encryption device 24. Examples of the resource pool 6 include various computers such as a server and a PC.

The resource pool 6 may have the same hardware configuration as the computer 5 illustrated in FIG. 9. The resource pool 6 may include a plurality of HDDs or SSDs as the storage unit 5c and, for example, redundant arrays of inexpensive disks (RAID) may be configured using them.

As illustrated in FIG. 21, the resource pool 6 may include, for example, an IP core DB 61. A plurality of IP cores are registered in the IP core DB 61, and a requested IP core is read from the IP core DB 61 in response to a request from the management machine 3A and may be transmitted to the management machine 3A. The IP core DB 61 may be realized by a storage such as the storage unit 5c.

For example, a vendor of the FPGA 21 or another provider may register an IP core in the resource pool 6 and may sell or provide the registered IP core.

The client machine 4 may transmit information indicating what process to realize, for example, information on a processing circuit 22 which is configured in the FPGA 21 such as information for specifying a process sequence or an IP core, to the management machine 3A. When a process sequence is transmitted from the client machine 4, the management machine 3A may select an IP core from the resource pool 6 based on the received process sequence and may cause an application 41 to use the processing circuit 22 based on the selected IP core.

Alternatively, for example, the client machine 4 may select an IP core to be used among IP cores registered in the resource pool 6 and may register use of the processing circuit 22 based on the selected IP core in the management machine 3A.

The management machine 3A may control and manage writing of the processing circuit 22 based on the IP core requested by the client machine 4 for the FPGA 21 of the host machine 2 which is used by a user of the client machine 4.

Regarding an encryption IP core 13c, the management machine 3A may acquire the encryption IP core 13c in the same was as in the embodiment and may write the acquired encryption IP core 13c to the FPGA 21. Alternatively, the management machine 3A may also acquire the encryption IP core from the resource pool 6.

At least one of the host machine 2, the management machine 3A, and the resource pool 6 may be disposed in a facility such as a data center.

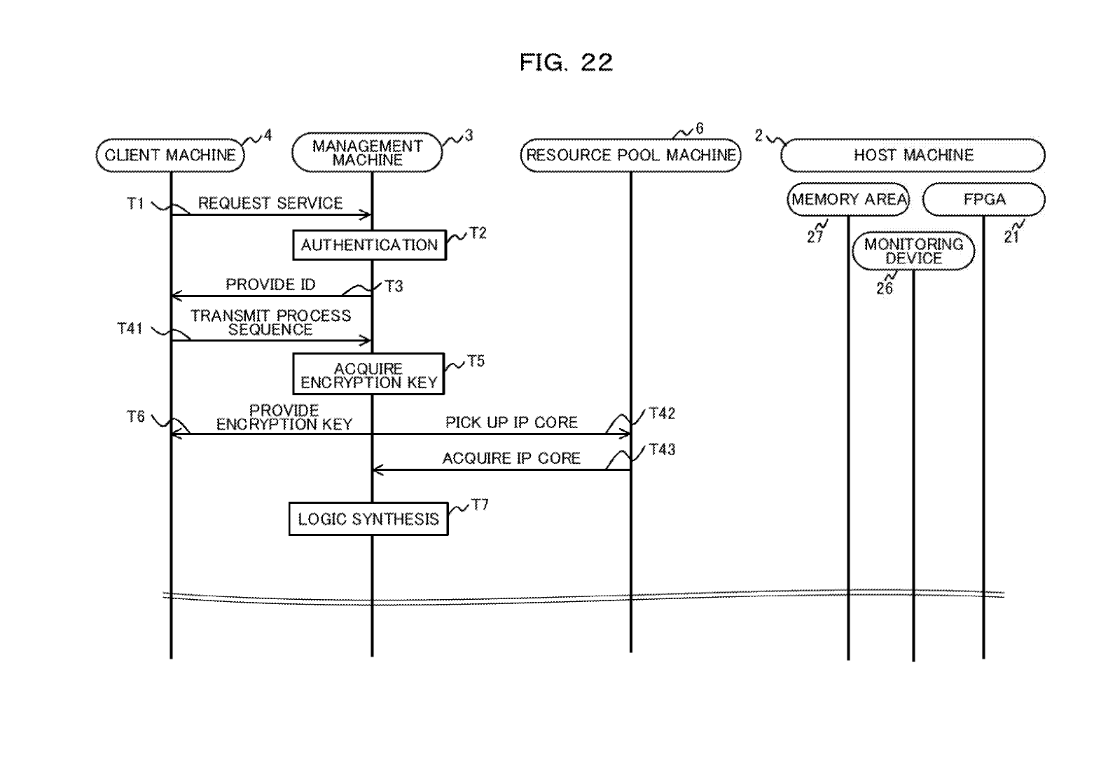

An example of an operation of the information processing system 1A having the above-mentioned configuration will be described below with reference to FIG. 22 with a focus on an operation different from those of the information processing system 1 according to the embodiment.

As illustrated in FIG. 22, the client machine 4 transmits a request for a service using the FPGA 21 to the management machine 3A (process T1: arrows (I′) in FIG. 21), acquire authentication from the management machine 3A (process T2), and is provided with an ID 42 (process T3: arrows (II) in FIG. 21).

The client machine 4 transmits a process sequence to be used to the management machine 3A (process T41). The management machine 3A acquires an encryption key (process T5) and provides the acquired encryption key to the client machine 4 (process T6).

The management machine 3A receiving the process sequence accesses the resource pool 6 connected via a network which is not illustrated, and picks up an IP core matching the process sequence from the IP core DB 61 (process T42: arrows (II-2) in FIG. 21). The management machine 3A acquires an IP core picked up from the resource pool 6 (process T43).

The processes of process T7 and subsequent thereto in FIG. 22 may be the same as in the information processing system 1 according to the embodiment.

In processes T42 and T43 in FIG. 22, an IP core may be directly handed over from the resource pool 6 to the host machine 2. In this case, writing of the IP core to the FPGA 21 subsequent to process T7 in FIG. 22 (see processes T7 to T9 in FIG. 6) may be performed, for example, by the resource pool 6 or the host machine 2 as will be described below. The IP core may include at least one of a process IP core and an encryption IP core.

For example, the management machine 3A may instruct the resource pool 6 to transmit an IP core matching the process sequence to the host machine 2.

In this case, the resource pool 6 may transmit the designated IP core in addition to a writing instruction to the FPGA 21 to the host machine 2 and the CPU 2a of the host machine 2 may write the IP core to the FPGA 21 based on the writing instruction. Alternatively, when the host machine 2 is connected to the resource pool 6 via a dedicated line, the resource pool 6 may write the designated IP core to the FPGA 21 via the dedicated line. In other words, the logic synthesis of the IP core may be performed by the resource pool 6 or the host machine 2.

As described above, according to the information processing system 1A according to the modified example, the same advantages as in the information processing system 1 according to the embodiment can also be achieved.

With an aspect in which a vendor of the FPGA 21 or the like provides an IP core which is supposed in the modified example, since the management machine 3A correlates an encryption key with a user and a process IP core, it is possible to appropriately manage an encryption key to be notified to a user.

In addition, an IP core which is used to write the processing circuit 22 to the FPGA 21 is selected among IP cores registered in the resource pool 6. Accordingly, as for the IP cores registered in the resource pool 6, for example, security risks may be determined in advance by the resource pool 6 or the management machine 3A. Accordingly, in addition to the techniques according to the embodiment and the modified example, it may be possible to further reduce the security risk by determining the security risk in advance.

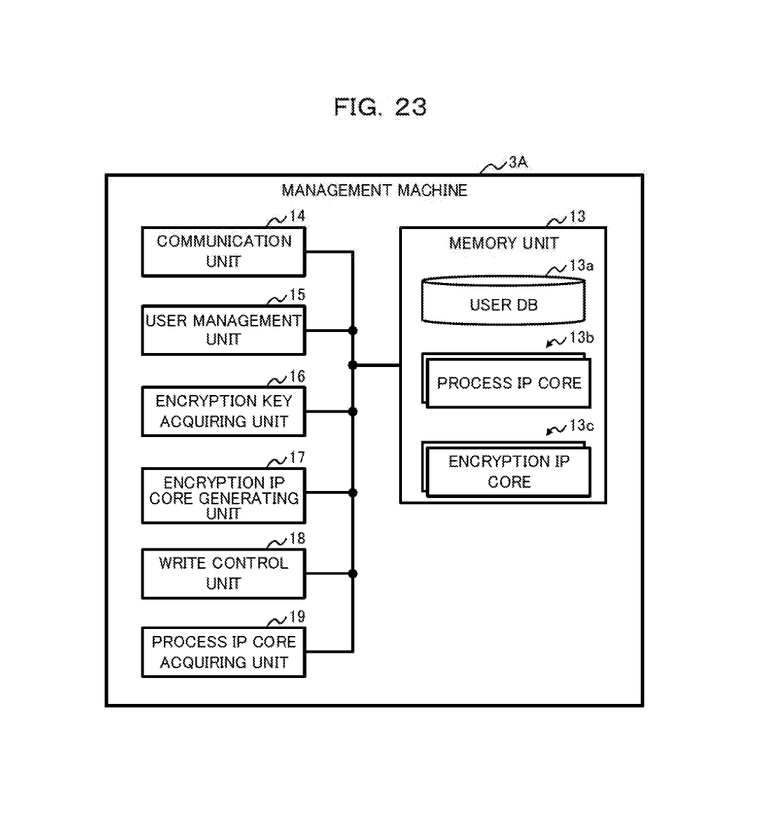

An example of a functional configuration of the management machine 3A according to the modified example will be described below with reference to FIG. 23. FIG. 23 is a block diagram illustrating the functional configuration of the management machine 3A according to the modified example. As illustrated in FIG. 23, the management machine 3A may include, for example, a process IP core acquiring unit 19 in addition to the functional configuration of the management machine 3 illustrated in FIG. 11.

The communication unit 14 which is an example of a reception unit may receive a request for configuring a processing circuit 22 in the FPGA 21 from the client machine 4, similarly to in the embodiment.

The process IP core acquiring unit 19 acquires a process IP core which is requested by the client machine 4 from the resource pool 6. The process IP core requested by the client machine 4 may be specified by the process IP core acquiring unit 19 based on the process sequence received from the client machine 4, or may be a process IP core which is selected with reference to the resource pool 6 by the client machine 4. For example, the process IP core acquiring unit 19 may perform the processes indicated by processes T42 and T43 in FIG. 22.

In other words, the process IP core acquiring unit 19 is an example of an acquisition unit that acquires at least one of first information and second information which satisfy the request from the client machine 4 from the resource pool 6.

The write control unit 18 may perform control of configuring the process IP core 13b and the encryption IP core 13c acquired by the management machine 3A in the FPGA 21.

When the process IP core is directly handed over from the resource pool 6 to the host machine 2, the management machine 3A can perform control of configuring the processing circuit 22 or the like in the FPGA 21 in response to an instruction to transmit the process IP core to the host machine 2 to the resource pool 6.

When the encryption IP core is directly handed over from the resource pool 6 to the host machine 2, the management machine 3A can perform control of configuring the encryption device 24 in the FPGA 21 in response to an instruction to transmit the encryption IP core to the host machine 2 to the resource pool 6.

The transmission instruction may be issued by at least one function of the communication unit 14, the write control unit 18, and the process IP core acquiring unit 19. In other words, at least one of the communication unit 14, the write control unit 18, and the process IP core acquiring unit 19 is an example of a control unit that performs control of configuring the processing circuit 22, the encryption device 24, and the like in the FPGA 21 based on the first and second information.

Whether the management machine 3A acquire a process IP core or/and an encryption IP core from the resource pool 6 or causes the resource pool 6 to directly transmit the process IP core or/and the encryption IP core to the host machine 2 may be determined depending on the function of the resource pool 6, the host machine 2, or the like. Alternatively, it may be determined depending on a storage state or an operating state of an IP core in the IP core DB 61.

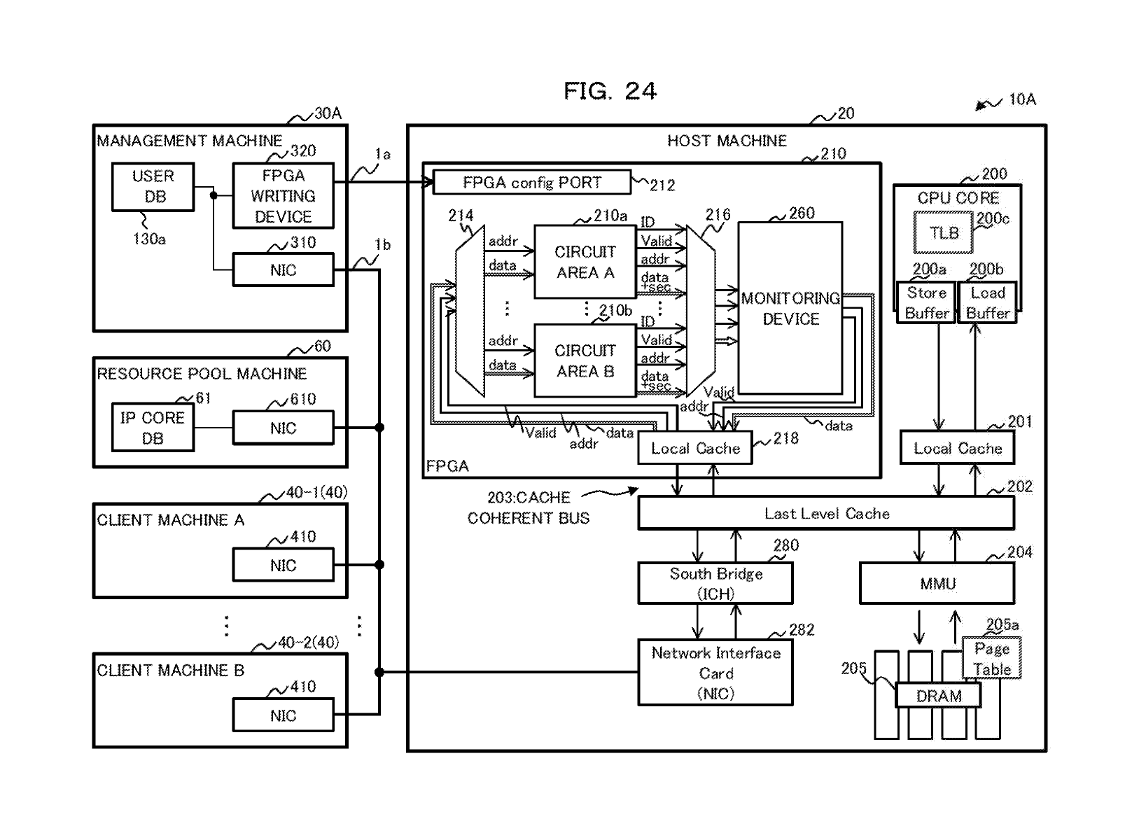

A practical example of the information processing system 1A according to the modified example will be described below with reference to FIG. 24. FIG. 24 is a block diagram illustrating a configuration of an information processing system 10A according to the practical example of the modified example. In FIG. 24, for the purpose of convenience, a CPU 3a and a memory 3b of a management machine 30A, CPUs 4a and memories 4b of client machines 40-1 and 40-2, and a CPU and a memory of a resource pool machine 60 are not illustrated. A configuration different from the information processing system 10 according to the practical example of the embodiment will be described below.

As illustrated in FIG. 24, the information processing system 10A may include, for example, a resource pool machine 60 in addition to the configuration of the information processing system 10.

The resource pool machine 60 may include an IP core DB 61 illustrated in FIG. 21. The resource pool machine 60 may include an NIC 610.

The NIC 610 is a device that connects the resource pool machine 60 to a network such as a LAN. The NIC 610 may be connected to the management machine 30, for example, in a wired or wireless manner or may be connected to the host machine 20 or the client machine 40.

The FPGA 210 of the host machine 20 may have any configuration of the practical example of the embodiment which has been described with reference to FIG. 14, the first modified example of the practical example illustrated in FIG. 19, and the second modified example of the practical example illustrated in FIG. 20.

### [2] Others

The techniques according to the embodiment and the modified example can be modified and changed as follows.

For example, the functional blocks of the host machine 2 illustrated in FIG. 10 may be merged or divided in an arbitrary combination. The functional blocks of the management machine 3 illustrated in FIG. 11 may be merged or divided in an arbitrary combination.

In the modified example of the embodiment, the information processing system 1A includes the management machine 3A and the resource pool 6, but the invention is not limited thereto. The function of any one of the management machine 3A and the resource pool 6 may be incorporated into the other device or the function of at least a part of the management machine 3A and the resource pool 6 may be integrated in one or more computers. In this case, the other device or the computer may serve as a management device that manages the host machine 2.

In the embodiment and the modified example, a plurality of, for example, two, logic circuits including the processing circuit 22, the peripheral circuit, and the encryption device 24 are configured in the FPGA 21, but the number of logic circuits configured in one FPGA 21 may be one or three or more. When a plurality of logic circuits are configured in one FPGA 21, different address areas of the memory 2b, for example, the memory areas 27, may be allocated to a plurality of processing circuits 22 in the FPGA 21.

In the embodiment and the modified example, the host machine 2 may include a plurality of FPGAs 21 and one or more logic circuits including the processing circuit 22, the peripheral circuit, and the encryption device 24 may be configured in each of the plurality of FPGAs 21. In this case, different address areas of the memory 2b may be allocated to the plurality of processing circuits 22 in the plurality of FPGAs 21.

In the embodiment and the modified example, the monitoring device 26 is commonly used by a plurality of logic circuits, but a plurality of monitoring devices 26 may be present in the host machine 2. In this case, each of the plurality of monitoring devices 26 may take change of one or more logic circuits.

In the embodiment and the modified example, the FPGA 21 may include encryption devices 24 smaller than the number of processing circuits 22. In this case, the encryption device 24 may hold information for correlating identification information with an encryption key such as the relationship information 261 of the monitoring device 260 illustrated in FIG. 14.

According to an aspect of the invention, it is possible to reduce a security risk in an information processing apparatus including a programmable logic device having a plurality of programmable circuit areas.

All examples and conditional language recited provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A programmable logic device comprising:
a plurality of programmable circuit areas;
an encryption unit configured to encrypt data based on process of an arithmetic processing unit; and first checking data added to the data to generate encrypted data, based on an encryption key corresponding to identification information allocated to the arithmetic processing unit, the arithmetic processing unit being implemented in a specific circuit area of the plurality of programmable circuit areas; and
a transmission unit configured to transmit identification information output from the specific circuit area and the encrypted data to an authentication unit,
wherein the authentication unit is configured to decrypt the encrypted data received from the transmission unit based on the encryption key corresponding to the identification information received from the transmission unit and to perform an authentication process of decrypted data based on the first checking data added to the decrypted data.

2. The programmable logic device according to claim 1, wherein the first checking data is checking data which is acquired by performing a specific process on the data based on the process of the arithmetic processing unit, and
the authentication process includes authenticating the decrypted data depending on whether second checking data which is acquired by performing the specific process on the decrypted data coincides with the first checking data added to the decrypted data.

3. The programmable logic device according to claim 1, wherein the arithmetic processing unit issues a write request for writing data based on the process of the arithmetic processing unit to a storage area allocated to the arithmetic processing unit, and
the authentication unit performs the authentication process based on data related to the write request before writing the data related to the writing request to the storage area.

4. The programmable logic device according to claim 3, wherein the transmission unit transmits an address of a write destination of the data related to the write request to the authentication unit in addition to the identification information output from the specific circuit area and the encrypted data, and
the authentication process includes authenticating received address of the write destination received from the transmission unit based on the received address of the write destination and an address of the storage area allocated to the arithmetic processing unit.

5. The programmable logic device according to claim 4, wherein the authentication unit stores management information for managing the identification information allocated to the arithmetic processing unit and the address of the storage area allocated to the arithmetic processing unit, and
the authentication process includes authenticating the received address of the write destination depending on whether an address which is managed by the management information and which corresponds to the identification information received from the transmission unit coincides with the received address of the write destination.

6. The programmable logic device according to claim 3, wherein the authentication unit writes the data related to the write request to the storage area allocated to the arithmetic processing unit when the authentication process related to the write request succeeds, and inhibits writing of the data related to the write request when the authentication process related to the write request fails.

7. An information processing apparatus comprising:
a programmable logic device configured to include a plurality of programmable circuit areas; and
an authentication unit,
wherein the programmable logic device includes
an encryption unit configured to encrypt data based on process of an arithmetic processing unit; and first checking data added to the data to generate encrypted data, based on an encryption key corresponding to identification information allocated to the arithmetic processing unit, the arithmetic processing unit being implemented in a specific circuit area of the plurality of programmable circuit areas, and
a transmission unit configured to transmit identification information output from the specific circuit area and the encrypted data to the authentication unit,
wherein the authentication unit is configured to decrypt the encrypted data received from the transmission unit based on the encryption key corresponding to the identification information received from the transmission unit and to perform an authentication process of decrypted data based on the first checking data added to the decrypted data.

8. The information processing apparatus according to claim 7, wherein the first checking data is checking data which is acquired by performing a specific process on the data based on the process of the arithmetic processing unit, and
the authentication process includes authenticating the decrypted data depending on whether second checking data which is acquired by performing the specific process on the decrypted data coincides with the first checking data added to the decrypted data.

9. The information processing apparatus according to claim 7, wherein the arithmetic processing unit issues a write request for writing data based on the process of the arithmetic processing unit to a storage area allocated to the arithmetic processing unit, and
the authentication unit performs the authentication process based on data related to the write request before writing the data related to the writing request to the storage area.

10. The information processing apparatus to claim 9, wherein the transmission unit transmits an address of a write destination of the data related to the write request to the authentication unit in addition to the identification information output from the specific circuit area and the encrypted data, and
the authentication process includes authenticating received address of the write destination received from the transmission unit based on the received address of the write destination and an address of the storage area allocated to the arithmetic processing unit.

11. The information processing apparatus according to claim 10, wherein the authentication unit stores management information for managing the identification information allocated to the arithmetic processing unit and the address of the storage area allocated to the arithmetic processing unit, and
the authentication process includes authenticating the received address of the write destination depending on whether an address which is managed by the management information and which corresponds to the identification information received from the transmission unit coincides with the received address of the write destination.

12. The information processing apparatus according to claim 9, wherein the authentication unit writes the data related to the write request to the storage area allocated to the arithmetic processing unit when the authentication process related to the write request succeeds, and inhibits writing of the data related to the write request when the authentication process related to the write request fails.

13. A processing method comprising:
encrypting data based on a process of an arithmetic processing unit and first checking data added to the data to generate encrypted data, based on an encryption key corresponding to identification information allocated to the arithmetic processing unit, the arithmetic processing unit being implemented in a specific circuit area of a plurality of programmable circuit areas, the plurality of programmable circuit areas being included in a programmable logic device;
transmitting identification information output from the specific circuit area and the encrypted data to an authentication unit; and
decrypting, by the authentication unit, received encrypted data based on the encryption key corresponding to received identification information and performing, by the authentication unit, an authentication process of decrypted data based on the first checking data added to the decrypted data.

14. The processing method according to claim 13, wherein the first checking data is checking data which is acquired by performing a specific process on the data based on the process of the arithmetic processing unit, and
the authentication process includes authenticating the decrypted data depending on whether second checking data which is acquired by performing the specific process on the decrypted data coincides with the first checking data added to the decrypted data.

15. The processing method according to claim 13, further comprising
issuing a write request for writing data based on the process of the arithmetic processing unit to a storage area allocated to the arithmetic processing unit, and
performing, by the authentication unit, the authentication process based on data related to the write request before writing the data related to the writing request to the storage area.

16. The processing method according to claim 15, wherein the transmitting includes transmitting an address of a write destination of the data related to the write request to the authentication unit in addition to the identification information output from the specific circuit area and the encrypted data, and
the authentication process includes authenticating received address of the write destination based on the received address of the write destination and an address of the storage area allocated to the arithmetic processing unit.

17. The processing method according to claim 16, further comprising storing, by the authentication unit, management information for managing the identification information allocated to the arithmetic processing unit and the address of the storage area allocated to the arithmetic processing unit, wherein
the authentication process includes authenticating the received address of the write destination depending on whether an address which is managed by the management information and which corresponds to the received identification information coincides with the received address of the write destination.

18. The processing method according to claim 15, further comprising writing, by the authentication unit, the data related to the write request to the storage area allocated to the arithmetic processing unit when the authentication process related to the write request succeeds, and inhibiting, by the authentication unit, writing of the data related to the write request when the authentication process related to the write request fails.
